(19) United States
(12) Patent Application Publication
(10) Pub. No.: US 2002/0147661 A1
(43) Pub. Date: Oct. 10, 2002

(54) Method of ordering and delivering picture data

(75) Inventors: Hiroshi Hatakama, Kawasaki (JP); Tetsuya Tsukahara, Kawasaki (JP); Takahisa Hatakeyama, Kawasaki (JP); Hiroyuki Yahagi, Kawasaki (JP); Kenji Ishii, Kawasaki (JP); Takashi Ueki, Kawasaki (JP); Satoshi Muramatsu, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 09/962,234

(22) Filed: Sep. 26, 2001

(30) Foreign Application Priority Data
Mar. 30, 2001 (JP) 2001-097920

(51) Int. Cl. G06F 17/60

(52) U.S. Cl. 705/26

(57) ABSTRACT

A method of delivering sample pictures containing information about how to purchase the original picture data. A computer system stores picture data received from mobile stations over a network. It then creates sample pictures from the stored picture data. Each sample picture contains ordering information that shows where to purchase the original version of the picture data. When a request is received from a terminal station on the network, the computer transmits such sample pictures to the requesting station.

### BACKGROUND OF THE INVENTION

1. Field of the Invention

The present invention relates to a method of ordering and delivering picture data over a network, as well as to a program product therefor. More particularly, the present invention relates to a method of ordering and delivering pictures collected from mobile stations, as well as to a program product therefor.

2. Description of the Related Art

Next few years will see great technological advancement in mobile communications environments, particularly in their data transport capabilities. The increased bandwidths of a new generation system will make it possible to send larger data files, such as photographs taken with a digital camera, to a server or other remote computer systems. That is, even a small mobile handset is expected to acquire the ability to handle complex image data, thus enabling expanded use of visual information in our daily life. For example, it will be possible for a person to take pictures and immediately upload them to his/her web pages, so that other people can view them and pay for downloading them.

Digital cameras are widely used today, allowing people to produce image data by simply shooting objects or scenes before them. The produced data may be registered to a website which collects photos from such local picture contributors. Mobile users will be able to enjoy data transfer rates up to 384 kbps with the forthcoming third-generation mobile telecommunications systems, known as the IMT-2000. This bandwidth is wide enough to handle video information (including voices), as well as still images. Note that, in the description of the present invention, the term “pictures” refers to all or part of those kinds of information.

Trading of pictures over the Internet requires marketing efforts, as in any other types of business in the real world. Having a dedicated website to show the products to prospective customers is one of the most effective ways of advertisement. However, here arise a problem in the copyright protection. To show a picture on a website is to permit the visitors to download the picture data for free. This is unavoidable because they really need to download an image data file to their local storage in order to view the picture on their terminal stations (e.g., computers and mobile handsets). Once downloaded, the picture data could be replicated pretty easily, in the absence of effective copyright protection systems.

One method to solve the above problem is to encrypt picture data files and sell a key to open them. More specifically, every picture for sale is converted into encrypted form and stored in the web server. When an order is received, the web server sends a relevant encrypted picture data file to the purchaser. In exchange for the payment, the website operator sends an appropriate decryption key to the purchaser, thus enabling him/her to extract the original picture data from the encrypted file.

In the case the above method is used, the website provides visitors with pages containing smaller low-quality “thumbnail” images, instead of allowing them to view the original pictures. Those sample pictures serve the purpose of informing the visitor of what kinds of pictures are available for sale. For successful business, it is necessary to invite as many potential customers as possible and encourage them to see a sample page. Effective advertisement techniques are particularly important to achieve the purpose, since the presence of such sample picture pages in the Internet is negligibly small, compared to its vast information space.

One efficient way of attracting people is to encourage individuals to pass on a marketing message to others, creating an exponential growth in the influence. Such marketing strategies are called “viral marketing,” and their concepts are described in the following literatures: Kim Brooks, “Germ Warfare: How to Spawn A Marketing Virus,” ClickZ Network, Oct. 26, 1998, pp. 1-4; Seth Godin and Malcolm Gladwell, “Unleashing the Ideavirus,” Do You Zoom, Inc., 2000.

However, the current sample page construction is not suitable for the recent marketing techniques described above, because of the lack of permanent association between thumbnail pictures and ordering information. Most web pages are written in the hypertext markup language (HTML). Conventionally, each thumbnail image is embedded in an HTML document as an inline object linked to another HTML document that is designed for shopping. Suppose here that a user extracts a thumbnail image from the document in an attempt to distribute that image alone. In this case, the recipients of this thumbnail image are unable to find how to purchase the original picture, because the extracted thumbnail has lost its link to the shopping page. That is, free distribution of sample pictures would contribute nothing to sales of pictures. It is therefore demanded to develop a system which maintains the ordering information in a sample picture.

### SUMMARY OF THE INVENTION

In view of the foregoing, it is an object of the present invention to provide a method of delivering sample pictures with information on how to purchase the original picture data.

Another object of the present invention is to provide a picture data ordering method for use with a system which distributes sample pictures with information on how to purchase their original picture data.

To accomplish the first object, according to the present invention, there is provided a method of distributing picture data over a network of computers. This method comprising the steps of: (a) storing picture data received from a mobile station over the network, wherein the stored picture data contains the original version of a picture; (b) creating a sample picture from the stored picture data, wherein the sample picture contains ordering information that describes where to purchase the original version of the picture; and (c) transmitting the sample picture to a terminal station on the network, in response to a request from the terminal station.

To accomplish the second object, according to the present invention, there is provided a method for use with a terminal station on a network to purchase picture data from a computer storing pictures. This method comprising the steps of: (a) receiving a sample picture from the computer, wherein the sample picture contains ordering information that describes where to purchase original version of a particular picture; and (b) in response to an instruction from a user of the terminal station, placing an order for the picture data according to the ordering information contained in the sample picture.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a conceptual view of the present invention;

FIG. 2 is a conceptual view of a system according to a first embodiment of the present invention;

FIG. 3 shows a typical hardware configuration of a content server for use in the preferred embodiments of the present invention;

FIG. 4 shows an example of a picture data sales procedure in the first embodiment;

FIG. 5 is a block diagram of a content server according to the first embodiment;

FIG. 6 shows an example of a membership table;

FIG. 7 shows an example of a picture property table;

FIG. 8 shows what data is exchanged between the content server and other equipment;

FIG. 9 is a flowchart which shows a picture data registration process in the content server;

FIG. 10 shows an example of a picture data entry page;

FIG. 11 is a block diagram of encryption/decryption functions;

FIG. 12 is a flowchart of a process of delivering sample pictures;

FIG. 13 shows an example of a picture listing page;

FIG. 14 is a flowchart which shows a picture searching process in the content server;

FIG. 15 shows an example of a search report page;

FIG. 16 shows an example of a picture details page;

FIG. 17 shows an example screen where an e-mail message carrying a sample picture is shown;

FIG. 18 is a flowchart which shows how the content server sells picture data;

FIG. 19 shows an example of a picture shopping page;

FIG. 20 is a system configuration in the second embodiment;

FIG. 21 is a block diagram of a content server according to the second embodiment;

FIG. 22 shows an example of a picture selection table;

FIG. 23 shows an example of a picture collection page showing pictures collected by an editor; and

FIG. 24 shows an example of a picture shopping page in the second embodiment.

### DESCRIPTION OF THE PREFERRED EMBODIMENTS

Preferred embodiments of the present invention will be described below with reference to the accompanying drawings.

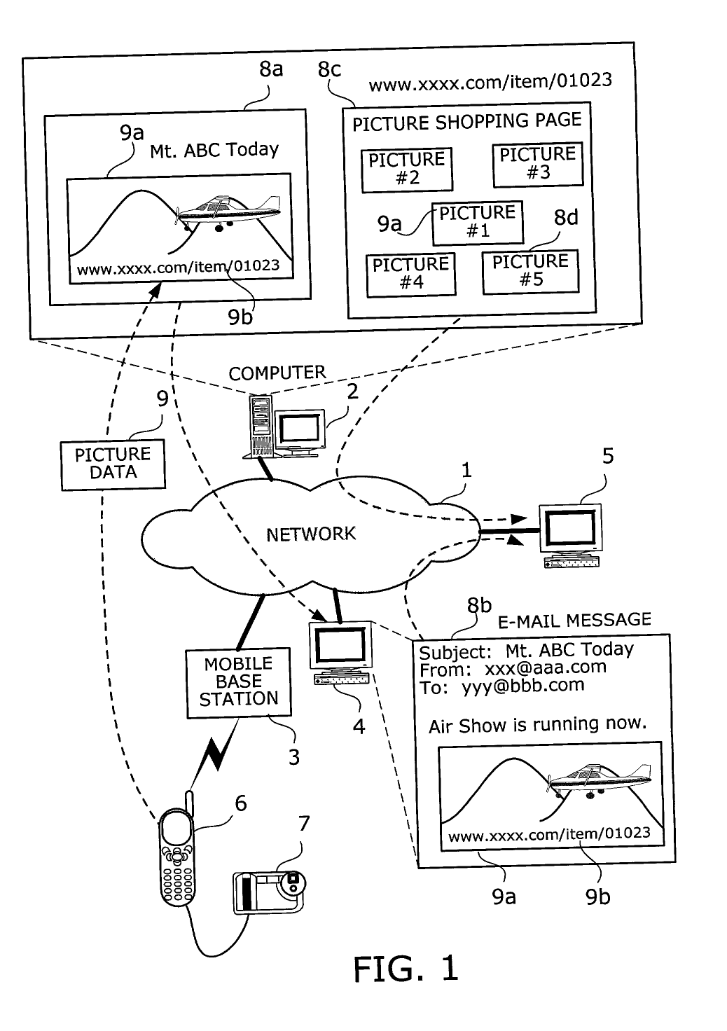

FIG. 1 shows the concept of a system where a picture data delivery method of the present invention is embodied. This system comprises the following elements: a computer 2, a mobile base station 3, and terminal stations 4 and 5. These elements are connected with each other by a network 1. The mobile base station 3 serves a mobile station 6 as part of a wireless data communication infrastructure. A digital camera 7 is coupled to, or integrated in, the mobile station 6.

In the system of FIG. 1, the user of the mobile station 6 takes a picture with his/her digital camera 7, thus producing picture data 9. The user sends the produced picture data 9 to the remote computer 2 through his/her mobile station 6, which invokes the following processing in the computer 2.

First, the picture data 9 is transferred from the mobile station 6 to the computer 2 over the network 1. The computer 2 saves the received picture data 9 into its local storage and then produces sample picture data 9a from the picture data 9. This sample picture data 9a contains ordering information 9b which indicates how to purchase the original picture data 9. More specifically, the ordering information 9b includes the name and location of a data file of a page where people can make an application for a purchase of the original picture data 9. The computer 2 publicizes the sample picture data 9a, so that it will be accessible to every terminal station 4 and 5 on the network 1. For example, the sample picture data 9a is placed on a web page 8a that provides information about a particular geographical area.

Upon request from the terminal station 4, the computer 2 sends the sample picture data 9a to the requesting terminal station 4 over the network 1. The terminal station 4 displays the sample picture in the received sample picture data 9a as in the web page 8a. The user of the terminal station 4 is allowed to distribute the sample picture data 9a as part of an e-mail message 8b. That is, the sample picture data 9a is attached to the email message 8b. In the example of FIG. 1, this message 8b is addressed to the user of the terminal station 5.

When the recipient (i.e., the user of the terminal station 5) opens the received e-mail message 8b, the sample picture is reproduced from the sample picture data 9a attached thereto. The recipient is invited to a picture shopping page 8c on the computer 2 by simply following the ordering information 9b embedded in the sample picture data 9a. This picture shopping page 8c contains the sample picture data 9a and other like sample pictures 8d that fall within the same category as that of the picture data 9. As such, the picture shopping page 8c is the first page that appears before the e-mail recipient who is attempting to purchase the original picture data 9. The purpose of this page 8c is to introduce at least two pictures in the same category, one of which is the picture data 9.

The user of the terminal station 5 selects, for example, the picture #1 from among those shown in the picture shopping page 8c and responds to instructions that appear on consequent pages. In this way, the user can purchase the picture data 9.

The above section has described how the present invention collects and distributes pictures over a network. According to the invention, ordering information for picture data 9 is embedded into its corresponding sample picture 9a for distribution purposes. If they wish, the recipients of this sample picture 9a can directly visit the correct place for shopping, using the embedded ordering information. This feature of the invention promotes the sales of the picture data 9 as well as other similar picture data.

The next section will discuss a first embodiment of the invention, assuming an Internet-based networking environment. Briefly, this embodiment applies to a business method as follows. A service provider collects pictures from reporters who have a mobile handset and digital camera. The collected pictures are sold to third parties through their server.

### First Embodiment of the Invention

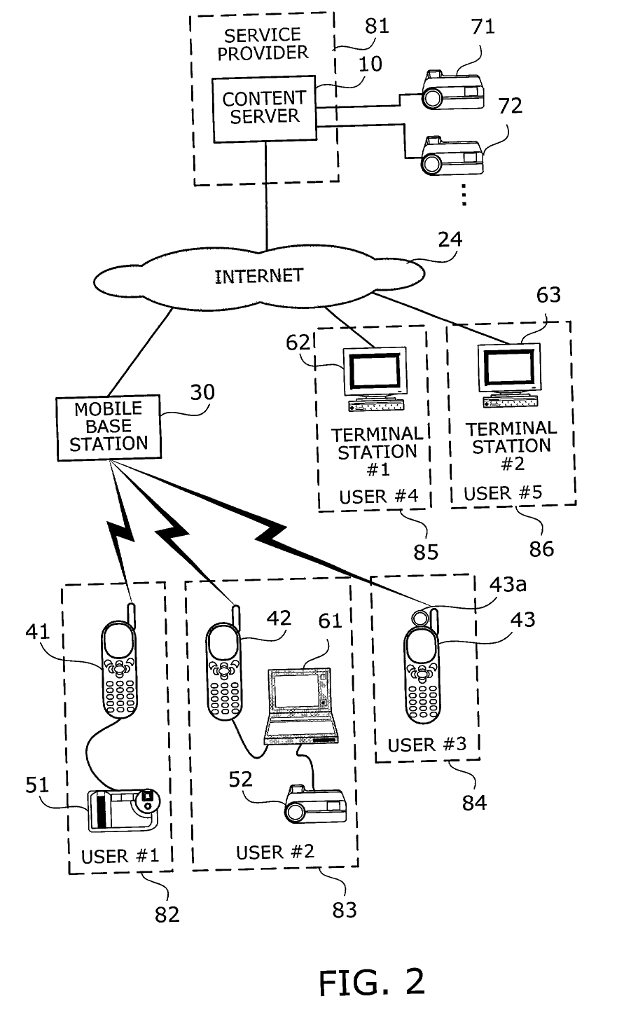

FIG. 2 shows the concept of a system according to a first embodiment of the present invention. This system comprises the following components: a content server 10, the Internet 24, a mobile base station 30, mobile phones 41 to 43, digital cameras 51 and 52, terminal stations 61 to 63, and fixed cameras 71 and 72.

The content server 10 is connected to the mobile base station 30 and terminal stations 62 and 63 via the Internet 24. The content server 10 is a server computer that provides the mobile phones 41 to 43 and terminal stations 62 and 63 with various data delivery services including sales of picture data. The content server 10 is also coupled to the fixed cameras 71 and 72, which are located at various places such as street corners, so that the views of streets will be captured in real time. Note that there are many such fixed cameras, although only two instances are shown in FIG. 2. The content server 10 makes the captured picture data accessible to Internet users.

The mobile base station 30 provides the mobile phones 41 to 43 with radio links for voice and data communication. The mobile base station 30 is also connected to the Internet 24, which enables mobile users to make access to computers on the Internet 24.

The mobile phones 41 to 43 are mobile radio communication terminals having both voice and data link functions. They comply with, for example, IMT-2000, the next-generation international mobile telecommunications standard. The first mobile phone 41, coupled to the digital camera 51, is capable to send picture data to the content server 10 via the mobile base station 30. The second mobile phone 42 is coupled to the terminal station 61 having a link to the digital camera 52. Here, the mobile phone 42 serves as a radio communication adapter for the terminal station 61 to upload picture data to the content server 10 via the mobile base station 30. The third mobile phone 43 has an integral digital camera 43a, so that picture data will be uploaded to the content server 10 via the mobile base station 30.

The digital cameras 51 and 52 contain a charge-coupled device (CCD) image sensor, on which an optical image is created by the lights collected through lenses. The CCD image sensor converts the optical image into electrical signals. The processor in the digital camera 51 and 52 produces picture data from those electrical image signals and saves it into a non-volatile memory device, such as a flash memory device, which is integrated in, or inserted in a memory slot of, the camera. The integral digital camera 43a of the mobile phone 43 provides the same image capturing functions as above. The digital cameras 51 and 52 have a data link function to send picture data to the mobile phone 41 and the terminal station 61, respectively.

The terminal station 61 is, for example, a notebook computer with a communication interface for the digital camera 52. It receives picture data from the digital camera 52 and saves into its internal storage. The stored picture data can be sent to the mobile phone 42 for data transfer.

The terminal stations 62 and 63 are, for example, personal computers at home. Web browser software is installed in those terminal stations 62 and 63, allowing the users to browse web pages that the content server 10 provides. The terminal stations 62 and 63 also have electronic mail facilities, including a capability of delivering picture data as an optional file attachment.

It is assumed here that the content server 10 is operated by a service provider 81 who provides picture data delivery services to its users 82 to 86. The first user 82 is the owner of the mobile phone 41 and digital camera 51. The second user 83 is the owner of the mobile phone 42, digital camera 52, and terminal station 61. The third user 84 is the owner of the mobile phone 43. The fourth user 85 is the owner of the first terminal station 62. The fifth user 86 is the owner of the second terminal station 63.

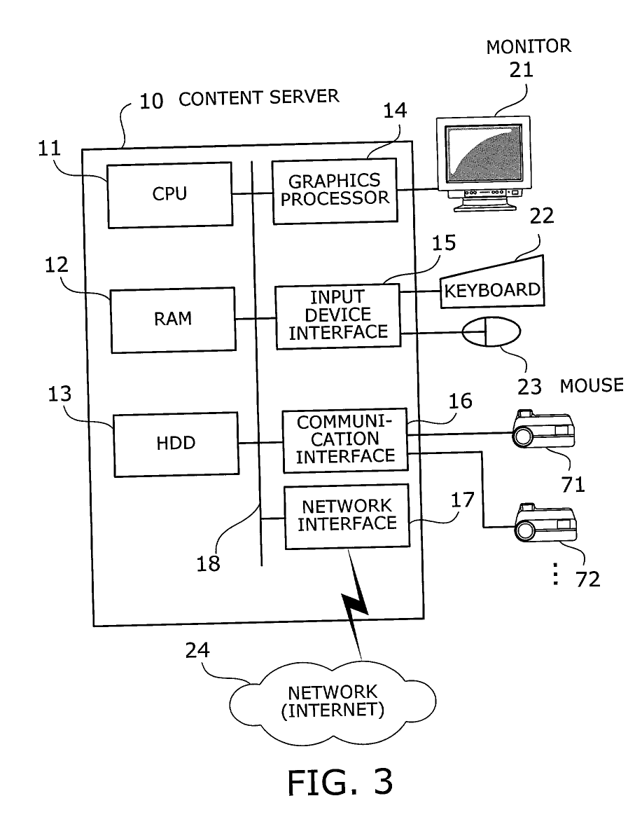

Referring to FIG. 3, a typical hardware configuration of the content server 10 for use in the embodiments of the present invention is shown. This content server 10 comprises the following functional elements: a central processing unit (CPU) 11, a RAM 12, a hard disk unit (HDD) 13, a graphics processor 14, an input device interface 15, a communication interface 16, and a network interface 17.

The CPU 11 controls the server 10 in its entirety, interacting with other elements via a common bus 18. The RAM 12 temporarily stores at least a part of operating system (OS) programs and application programs that the CPU 11 executes, in addition to other various data objects manipulated at runtime. Besides containing the operating system and other software programs, the HDD unit 13 stores website contents, including picture data.

The graphics processor 14 produces video images in accordance with drawing commands from the CPU 11 and displays them on the screen of an external monitor unit 21 coupled thereto. The input device interface 15 is used to receive signals from external input devices, such as a keyboard 22 and a mouse 23. Those input signals are supplied to the CPU 11 via the bus 18.

The communication interface 16 is a computer peripheral interface, such as IEEE 1394 serial ports, to link with the fixed camera 71 and 72. The communication interface 16 accepts picture data from the fixed cameras 71 and 72 and transfers it to the CPU 11 or HDD unit 13. The network interface 17 is connected to a wide area network, such as the Internet 24, allowing the CPU 11 to exchange data with other computers.

While FIG. 3 shows the content server 10, similar hardware structures would also be applied to the terminal stations 61 to 63, except that the communication interface 16 may not always be installed. The first terminal station 61 has a communication interface 16 to link with its local digital camera 52 and mobile phone 42, while the second and third terminal stations 62 and 63 do not.

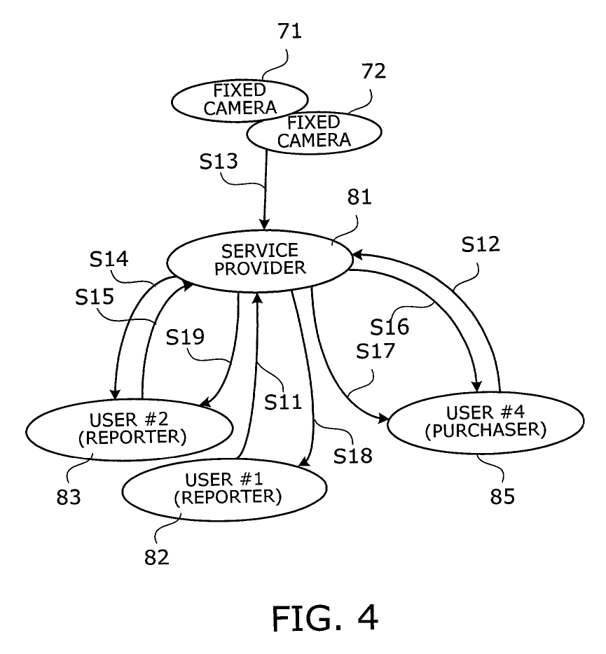

FIG. 4 shows an example of a picture data sales procedure in the first embodiment, in which the above-described system of FIG. 2 operates as follows. First, the first user 82 takes a picture (e.g., scenic shot) with the digital camera 51 from his/her own motives. The resultant picture data is held in the digital camera 51. Using his/her mobile phone 41, the first user 82 uploads this picture data from the digital camera 51 to the content server 10 (step S11). On the other hand, the fourth user 85 makes access to the content server 10 through his/her terminal station 62, where he/she tries to search for some desired photos, specifying the name of a place (e.g., “Shibuya”) and other appropriate keywords (e.g., “traffic condition”). If this search ends up with an unsatisfactory result, the fourth user 85 requests the content server 10 through his/her terminal station 62 to collect new pictures that would match his/her need (step S12).

Upon receipt of the request, the content server 10 captures new pictures with its fixed cameras 71 and 72 if they are appropriate for the received request (step S13). If the fixed camera 71 and 72 are not appropriate, then the content server 10 makes access to the mobile base station 30 to receive information about the locations of mobile phones owned by particular users who are previously registered. The mobile communication system has this kind of location information because it keeps track of mobile stations in each base station's radio coverage areas through what is known as the location updating processes, including measurement of radio waves transmitted from mobile stations. The content server 10 uses a list of such mobile phones and their locations to identify which one is appropriate for the fourth user's request.

Suppose here that the second user 83 is among this registered user group and he/she happens to be visiting the requested place. Then the content server 10 sends a message to the mobile phone 42 of the second user 83, requesting him/her to take a picture (step S14). In this way, the content server 10 routes the request from the fourth user 85 to the second user 83. The second user 83 sees the request message on the screen of the mobile phone 42 and takes the requested photos (e.g., scenic shots) with his/her digital camera 52. The second user 83 uploads the resultant picture data from the digital camera 52 to the content server 10, using his/her terminal station 61 and mobile phone 42 (step S15).

The content server 10 saves the received pictures into its local storage, while producing and registering their sample pictures. At this stage, the content server 10 updates the list of pictures for sale, so that links to the produced sample picture data will be included in the list. Further, the content server 10 embeds ordering information in each sample picture data, which includes an order entry page location to allow the users to purchase desired pictures. The order entry page is prepared as an HTML document file, and its location information is provided in the form of, for example, a Uniform Resource Locator (URL) of the file. More specifically, the sample picture data contains ordering information in the form of an image of a character string, which may be embedded into, or overlaid on, some part of the sample picture image. Anyone having an Internet connection can view the sample pictures on the content server 10, which is a free service of the service provider 81 while the original pictures are for pay.

Now that new pictures are ready, the fourth user 85 checks the picture list on the content server 10 and browses the sample pictures. If a desired picture is found, the fourth user 85 requests the content server 10 to lead him/her to a picture shopping page, simply following the instructions displayed on the web browser screen. In response to this access request, the content server 10 sends to the terminal station 62 a picture shopping page which is relevant to the ordering information embedded in the selected sample picture data. According to guidance messages in the picture shopping page being displayed on the terminal station 62, the fourth user 85 enters necessary information for his/her purchase. This order is transmitted from the terminal station 62 to the content server 10. After checking the details of the received order, the content server 10 permits the terminal station 62 to download the non-degraded original picture data that the fourth user 85 has requested (step S16).

When the downloading is finished, the service provider 81 sends a bill to the fourth user 85 (step S17). The service provider 81 confirms the corresponding bill payment from the fourth user 85, and after deducting their commission, the service provider 81 pays the remaining amount to the person who provided the picture. In the case the first user 82 is the source of the picture, the service provider 81 pays the money to the first user 82 (step S18). Or, in the case the second user 83 is the source, the service provider 81 rewards the second user 83 (step S19). In actuality, however, the fourth user 85 may have signed a fixed rate service contract, instead of a usage-based service contract with the service provider 81. The reward to the first user 82 or second user 83 depends on which contract has been made between the service provider 81 and service receiver 85.

The first and second users 82 and 83 sell the photos they took to the fourth user 85 in the way described above. They allow the fourth user 85 and any other users to freely copy and distribute their sample picture data. For example, the fourth user 85 can send a sample picture and its URL to another user, e.g., the fifth user 86, using e-mail functions of his/her terminal station 62. The fifth user 86 sees the sample picture displayed on his/her terminal station 63 and purchases the original picture if it is interesting to him/her. Here, the ordering information embedded in the sample picture helps him/her proceed with the purchase. In the same way as the fourth user 85 did, the fifth user 86 obtains a non-degraded copy of the original picture data from the content server 10.

The non-degraded copy of a picture is guarded from unauthorized duplication, through the use of an appropriate copyright protection mechanism. The system of the first embodiment encrypts picture data products as will be described in a later section.

In the process of purchasing a picture, the content server 10 downloads a series of pages according to the ordering information of a specified sample picture, the very first page being a picture shopping page. Besides providing information about the requested picture, the picture shopping page is designed to promote other pictures of the same kind as well, presenting one or more similar sample pictures to the requesting user. From the user's perspective, the picture shopping page enables him/her to find other similar pictures without explicitly requesting a picture data search. From the service provider's perspective, the above page arrangement develops a cross-selling effect, increasing the chances of additional sales to the same customer.

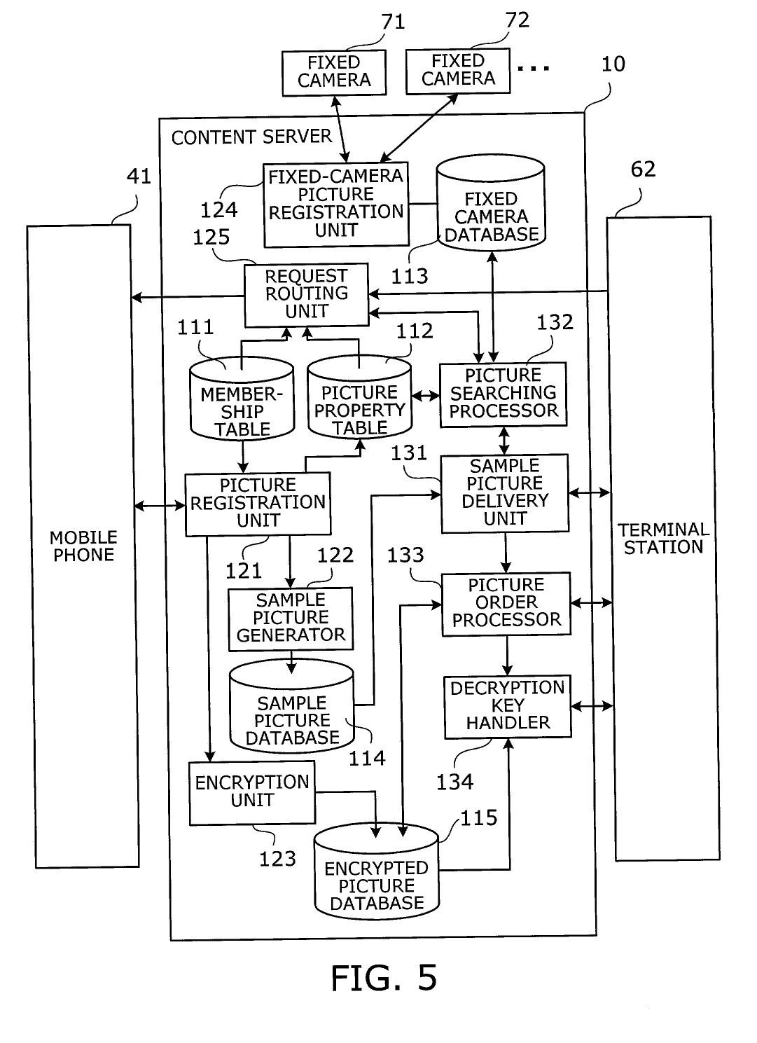

FIG. 5 is a block diagram of the content server 10 according to the first embodiment of the present invention. While the content server 10 interacts with many mobile phones and terminal stations, FIG. 5 shows only one set of them, a mobile phone 41 and a terminal station 62. It is assumed that the mobile phone 41 is used by a registered photo-providing user, and that the terminal station 62 is used by a purchaser.

The content server 10 has the following two tables and three databases: a membership table 111, a picture property table 112, a fixed camera database 113, a sample picture database 114, and an encrypted picture database 115. The following describes what records are maintained in those tables and databases.

The membership table 111 stores the identifier and personal information of each photo-providing user who enrolled himself/herself as a reporter. The picture property table 112 maintains the identifier and picture classification code of each registered picture.

The fixed camera database 113 accumulates picture data sent from the fixed cameras 71 and 72. Each picture registered in the fixed camera database 113 is stored together with a record representing the place and date of capturing. The sample picture database 114 stores sample pictures with a lower quality, which are produced from original pictures received from the photo-providing membership. The encrypted picture database 115 stores the original pictures in encrypted form, which are referred to herein as the encrypted picture files.

In addition to the above tables and databases, the content server 10 has the following processing functions: a picture registration unit 121, a sample picture generator 122, an encryption unit 123, a fixed-camera picture registration unit 124, a request routing unit 125, a sample picture delivery unit 131, a picture searching processor 132, a picture order processor 133, and a decryption key handler 134.

The picture registration unit 121 operates as follows, in response to a picture registration request sent from the mobile phone 41 or other mobile stations. When a new picture is received, the picture registration unit 121 supplies the data to the sample picture generator 122 to generate a sample picture. The picture data is also passed to the encryption unit 123 to produce an encrypted picture file. Further, the picture registration unit 121 receives information about the picture data from the source user and registers it into the picture property table 112. This information is referred to as the “picture properties.” The picture property record also includes information on who took the picture and where the corresponding sample picture data is stored; the former information is retrieved from the membership table 111, while the latter is obtained from the sample picture generator 122.

The sample picture generator 122 produces a sample picture from the source picture received from the picture registration unit 121, by degrading the image quality and adding ordering information for prospective purchasers. The ordering information includes, for example, the URL assigned to the picture order processor 133, picture ID, and the title of the picture. Such text is placed at some appropriate portion (e.g., edge) of the picture image. Another method is to include the text in the file name of the picture. Yet another method is to record the ordering information as a picture property.

Further, it is possible to embed such information into a picture by using IP3, an image-based information navigation system developed by Visionarts Inc., Japan. The IP3 technology provides a special graphic icon with embedded URLs for use in a particular application. By clicking the icon, the application makes access to remote information that is associated with the icon.

It is also possible to employ a special mechanism to handle link information in the image exchange facilities of mobile phone networks. With this mechanism, the user at the receiving end can jump to a web page prepared for purchasing non-degraded original picture data through a simple operation on a received sample picture.

As already mentioned, the sample picture generator 122 intentionally degrades the image quality of a sample picture when producing it from a given source picture. One simple example of this degradation processing is to reduce the size of an image (i.e., decimate pixels in both vertical and horizontal directions). Another example is to reduce the color resolution (extremely, to convert to a monochrome picture). Such degradation processing yields a sample picture whose file size is smaller than that of the source picture. The sample picture generator 122 saves the created sample picture file into the sample picture database 114.

The encryption unit 123 encrypts picture data supplied from the picture registration unit 121, using an appropriate encryption key. The resultant encrypted picture file is saved into the encrypted picture database 115, together with the associated encryption key.

The fixed-camera picture registration unit 124 receives pictures from the fixed cameras 71 and 72. It saves the received picture data into the fixed camera database 113.

The sample picture delivery unit 131 is responsive to an access request from the terminal station 62. Consulting the sample picture database 114, it compiles a sample picture listing page for delivery to the requesting terminal station 62. The user of the terminal station 62 may also request the image of a particular sample picture, in which case the sample picture delivery unit 131 retrieves a relevant record (including the image file and detailed picture properties) from the sample picture database 114 and sends it back to the requesting terminal station 62. The sample picture delivery unit 131 is also responsible for handling a picture search request from the terminal station 62. Upon request, the sample picture delivery unit 131 activates the picture searching processor 132 to execute a search and receives the result. The search result is transmitted to the terminal station 62 in the form of a picture search report page.

The picture searching processor 132 scans the picture property table 112 and fixed camera database 113 in response to a picture search request from the sample picture delivery unit 131. If there are picture data entries that satisfy the given search criteria, the picture searching processor 132 passes their information to the sample picture delivery unit 131.

The picture order processor 133 controls the payment procedure for executing an order of a picture(s), which occurs subsequently to a purchase request from the terminal station 62. This procedure includes, for example, a step of accepting billing information (e.g., his/her credit card number) from the purchaser. When such information is received, the picture order processor 133 retrieves a relevant encrypted picture file out of the encrypted picture database 115 and sends it the requesting terminal station 62. It also asks the decryption key handler 134 to deliver a decryption key to the purchaser.

Upon request from the picture order processor 133, the decryption key handler 134 first requests the terminal station 62 to provide its own identifier (e.g., CPU ID). Then it interacts with the encrypted picture database 115 to retrieve the encryption key that was used to produce the encrypted picture file sent to the terminal station 62. After that, the decryption key handler 134 creates permission data by encrypting the retrieved encryption key with the identifier of the terminal station 62, and it sends the created permission data to the terminal station 62. The terminal station 62 can decode this permission data by using its own identifier as the decryption key.

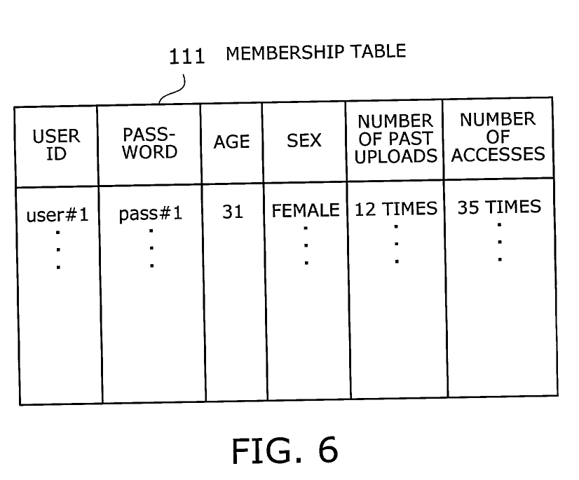

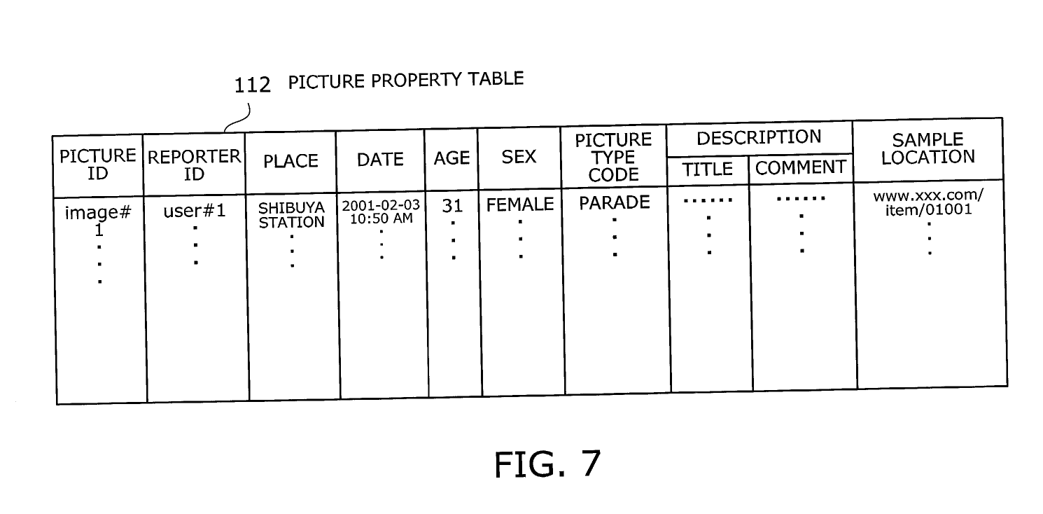

As has been briefly described in an earlier part of the description, the content server 10 employs a membership table 111 and a picture property table 112. Referring FIGS. 6 and 7, the next section will provide the details of those two data tables.

FIG. 6 shows an example of the membership table 111. This membership table 111 has the following data fields for each membership entry: user ID, password, age, sex, the number of past uploads, and the number of accesses. The “User ID” field contains a unique identifier of a user. The “Password” field stores a password that the user has previously defined in association with his/her user ID. The “Age” field shows the user's age. The “Sex” field shows whether the user is male or female. The “Number of past uploads” field indicates how many pictures the user has uploaded to the content server 10. The “Number of accesses” field serves as an access counter, which shows how many times other people made access to the user's pictures.

While the membership table 111 of FIG. 6 has “Age” and “Sex” fields to store the user's personal profile, it is not intended to limit the invention to this specific table content. The membership table 111 may have other user profile fields, such as hobbies and camera experience. Note that the “Age” and “Sex” fields are not mandatory items to be filled in; they can be left blank.

FIG. 7 shows an example of the picture property table 112. This picture property table 112 has the following data fields for each picture entry: “Picture ID,” “Reporter ID,” “Place,” “Time,” “Age,” “Sex,” “Picture Type Code,” “Description,” and “Sample Location.”

First, the “Picture ID” field contains a unique identifier of a registered picture. The “Reporter ID” field stores the user ID of a person who registered the picture. This person is referred to herein as the “reporter.” The “Place” and “Time” fields show where the picture was taken and when. The “Age” field shows the reporter's age. The “Sex” field shows whether the reporter is male or female. The “Picture Type Code” field stores a picture type identifier (or picture type code) which indicates what kind of object the registered picture represents. The “Description” field stores text information given by the reporter. More specifically, this field is divided into two subfields, named “Title” and “Comment.” The “Title” subfield shows the subject of the registered picture, while the “Comment” subfield stores explanatory notes about the picture. Lastly, The “Sample Location” field contains a pointer (e.g., URL) that indicates where the associated sample picture is stored.

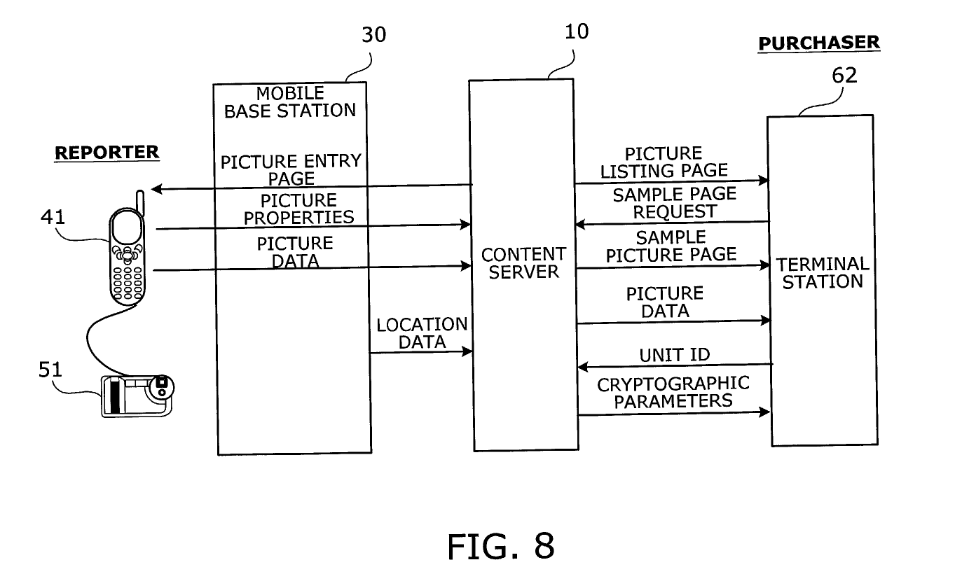

Referring now to FIG. 8, three tasks of the above-described content server 10 will be briefly described below. FIG. 8 shows what kind of data is exchanged between the content server 10 and other stations. This diagram assumes such a scenario that a reporter uses his mobile phone 41 to upload a picture to the content server 10, and a purchaser buys the picture through his/her terminal station 62. This scenario involves the following data exchange:

The reporter's mobile phone 41 sends picture data and picture properties to the content server 10.

The content server 10 sends a picture data entry page to the reporter's mobile phone 41.

The mobile base station 30 notifies the content server 10 of the location of the mobile phone 41.

The content server 10 supplies the purchaser's terminal station 62 with a picture listing page, a sample picture data, picture data, and cryptographic parameters.

The purchaser's terminal station 62 sends a sample page request and unit ID to the content server 10.

The content server's roles in the above data interaction are largely divided into the following three tasks: picture data registration task, sample picture delivery task, and picture order processing task. The picture data registration task is for registering given picture properties, sample picture data, and encrypted picture data, based on the picture data and properties received from a registered reporter's terminal (e.g., mobile phone 41). The sample picture delivery task provides sample pictures to terminal stations (including mobile stations) of general users. The picture order processing task delivers an order entry page and picture data to general users when they demand such data.

### Picture Data Registration Task

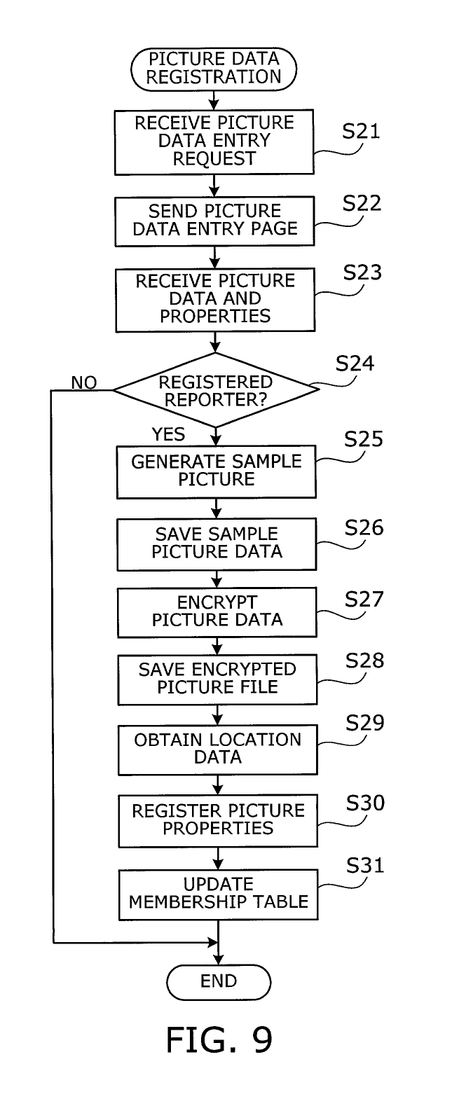

FIG. 9 is a flowchart of a typical picture data registration task executed by the content server 10. This task comprises the following steps:

(S21) The picture registration unit 121 receives a picture data entry request from a registered reporter.

(S22) The picture registration unit 121 sends a picture data entry page back to the requesting mobile station.

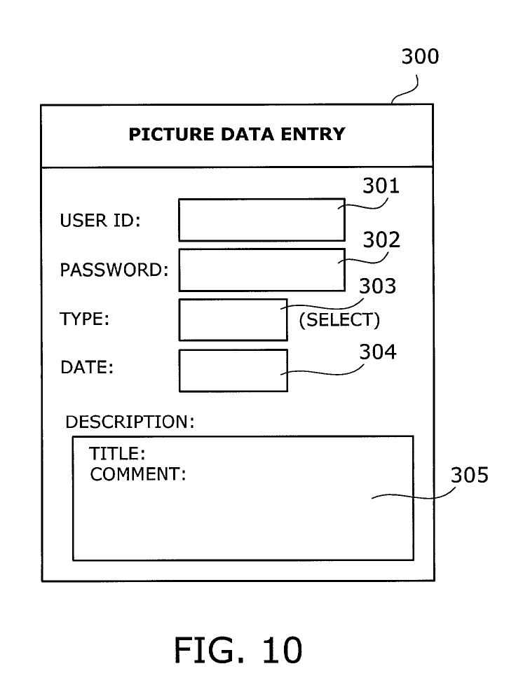

FIG. 10 shows an example of such a picture data entry page. This picture data entry page 300 has the following data fields: a user ID field 301, a password field 302, a picture type field 303, a date field 304, and a picture description field 305. The user fills out this picture data entry page 300 on his/her mobile station. More specifically, the user enters his/her own user ID and password into the user ID field 301 and password field 302.

The picture type field 303 is prepared for the user to select the type of the picture he/she is uploading. There is a predefined list of type names, such as “Station Area,” “Mountain View,” and “Event,” which allows the user to fill out the picture type field 303 by choosing one from among those in the list. The date field 304 is used to record when the user took the picture. Lastly, in the picture description field 305, the user gives a title and comment to the picture that he/she is uploading.

The user fills out all the above items in the picture data entry page 300 and operates some keys (not shown). Then those items are transferred as the picture's properties from his mobile phone to the content server 10.

(S23) Referring back to FIG. 9, the picture registration unit 121 receives picture data and picture properties from the mobile station. The picture properties include the following items: user ID, password, picture type, date, and picture description.

(S24) The picture registration unit 121 determines whether the requesting user is a registered reporter. More specifically, the picture registration unit 121 scans the membership table 111 to find a membership entry relevant to the user ID that is included in the received picture properties. If there is a match in the membership table 111, the picture registration unit 121 identifies the requesting user as a registered reporter, and it advances the process to step S25. If no relevant database entry is found, the picture registration unit 121 determines that the requesting user is not authorized as a reporter. The process should be terminated if this is the case, optionally leaving to him/her such a message as “You have to sign up for our membership.”

(S25) The picture registration unit 121 passes the received picture data to the sample picture generator 122, requesting it to create a sample picture. Out of the given picture data, the sample picture generator 122 first produces an image with a lowered quality and then embeds ordering information into that image, thereby creating a sample picture for the source picture.

(S26) The sample picture generator 122 enters the created sample picture to the sample picture database 114, and it notifies the picture registration unit 121 of the storage location of the sample picture data.

(S27) The picture registration unit 121, on the other hand, asks the encryption unit 123 to encrypt the received picture data. With an appropriate encryption key that has been determined randomly, the encryption unit 123 encrypts the given picture, thereby producing an encrypted picture file.

(S28) The encryption unit 123 saves the resultant encrypted picture file into the encrypted picture database 115, together with its associated encryption key.

(S29) The picture registration unit 121 interacts with the mobile base station 30 to inquire about the location of the mobile station that has requested a picture data entry page. From the obtained mobile location data, the picture registration unit 121 identifies the name of the place that the reporter is currently visiting.

(S30) The picture registration unit 121 registers the picture properties to the picture property table 112 as a new entry. Here, the “Picture ID” field of that entry contains a picture ID that is assigned to the received picture data. The “Reporter ID” field, “Date” field, “Picture Type Code” field, and “Picture Description” field are filled out with the relevant items of the received picture properties. The place name identified at step S29 is entered to the “Place” field. The “Age” and “Sex” fields are copied from the corresponding items of a relevant record in the membership table 111, the record being associated with the user ID of the reporter. The “Sample Location” field is filled out with a pointer that is directed at the sample storage location provided at step S26.

(S31) The picture registration unit 121 updates the requesting reporter's record in the membership table 111. More specifically, it increments the value in the “Number of Past Uploads” field by one.

The above-described steps permit users to upload and register their picture works to the content server 10. In the first embodiment of the invention, this picture registration service is offered only to a limited group of users (or registered reporters) who have signed up for that service. This membership system is expected to work effectively in controlling illegal uploads of pictures (e.g., uploading a picture that was duplicated without permission of the copyright holder).

While the flowchart of FIG. 9 includes the step S29 of obtaining the mobile location from the mobile base station 30, the invention should not be limited to this method. One alternative method is such that the requesting reporter notifies the content server 10 of his/her current location.

Further, the above flowchart may be modified in such a way that the date and time information be extracted automatically from the base station 30, together with the mobile location. This kind of techniques are disclosed in, for example, the Unexamined Japanese Patent Publication No. 9-65268 (1997), entitled “Electronic Still Camera Device.”

The mobile location information is provided normally in the form of latitude and longitude. This data format, however, is not suitable for searching. One method to solve this problem is to convert the given location data into different data formats, such as street addresses and property names, when registering the location to the picture property table 112. More specifically, the content server 10 may be equipped with a geographical database (i.e., maps) containing the names of stations, parks, and other major facilities, as well as street addresses, in association with the geographical coordinates (i.e., latitudes and longitudes). A given latitude-longitude pair is thus converted into, for example, the name of a particular building, or a specific street address, or both. The “Place” field of the picture property table 112 stores such familiar information, making it easier for a user to search for a desired picture by specifying a particular place name.

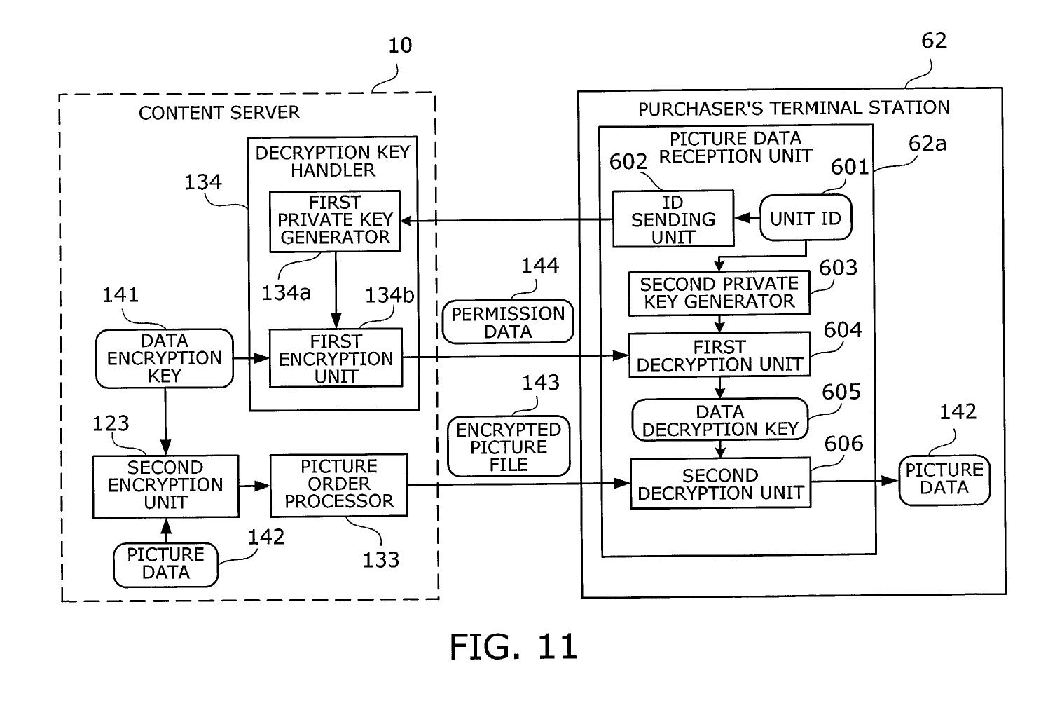

The first embodiment of the invention employs an encryption and decryption mechanism built on the basis of techniques disclosed in the U.S. Pat. No. 5,857,021 to Kataoka et al., entitled “Security System for Protecting Information Stored in Portable Storage Media.” FIG. 11 is a block diagram of the encryption and decryption functions implemented in the content server 10 and terminal station 62. Note that FIG. 11 is focused on their cryptographic functions, while omitting unrelated elements. The illustrated system includes several elements not shown in FIG. 5; the next paragraphs describe those new elements.

In the content server 10, the decryption key handler 134 comprises a first private key generator 134a and a first encryption unit 134b. The first private key generator 134a creates a private key from a unit ID 601 that is provided by the terminal station 62. Here, the unit ID 601 refers to a unique identifier assigned to the terminal station 62.

The content server 10 keeps a data encryption key 141 that was used to encrypt the picture data. The first encryption unit 134b encrypts this data encryption key 141, using the private key created by the first private key generator 134a. The resultant data is referred to as the permission data 144. The first encryption unit 134b sends this permission data 144 to the terminal station 62.

The terminal station 62 has a picture data reception unit 62a, which comprises the following elements: an ID sending unit 602, a second private key generator 603, a first decryption unit 604, and a second decryption unit 606. As mentioned above, the terminal station 62 owns its unique unit ID 601. The ID sending unit 602 sends this unit ID 601 to the content server 10 for use in the task of generating permission data 144. The unit ID 601 is also supplied to the second private key generator 603 to create a private key. With this private key, the first decryption unit 604 decodes the permission data 144 received from the content server 10, thus yielding a data decryption key 605. Note that the resultant data decryption key 605 is identical with the data encryption key 141 used in the content server 10. The second decryption unit 606 reproduces the original picture data 142 by decoding the encrypted picture file 143 with the data decryption key 605.

With the above-described processing elements, the content server 10 and terminal station 62 operates as follows. When an order for a picture is received, the second encryption unit 123 encrypts the ordered picture data 142 with a data encryption key 141. The picture order processor 133 delivers the resultant encrypted picture file 143 to the requesting terminal station 62. The terminal station 62 sends its own unit ID 601 to the content server 10 through the ID sending unit 602. Based on the received unit ID 601, the first private key generator 134a produces a private key. Then the first encryption unit 134b creates permission data 144, using the produced private key to encrypt the data encryption key 141 of the encrypted picture file 143. The created permission data 144 is sent to the terminal station 62.

Also in the terminal station 62, the second private key generator 603 produces the same private key as that in the content server 10, based on the unit ID 601. The two private keys are identical with each other because the same seed data (i.e., unit ID 601) is used at the both ends. It is therefore possible for the terminal station 62 to obtain a data decryption key 605 by decoding the received permission data 144 with the locally-created private key. Since the obtained data decryption key 605 equals the data encryption key 141, the encrypted picture file 143 can be deciphered with this data decryption key 605. In this way, the terminal station 62 receives the ordered picture data 142 successfully.

As seen from the above explanation, the content server 10 is designed to supply the terminal station 62 with the data encryption key 141, after ciphering it with the unit ID of the receiving terminal station 62. This mechanism prevents the encrypted picture file 143 from being intercepted and decoded at an unauthorized terminal. In other words, only the terminal station 62 can reproduce the original picture data 142. The mechanism of FIG. 11 serves well for the protection of copyrights.

The processing functions of the terminal station 62 (FIG. 11) are provided by installing a decoding software program. This program is implemented as a Java script or plug-in which is downloadable from the content server 10, along with an encrypted picture file.

As an alternative method of security protection, the purchaser may be requested to enter his/her user ID and password which have been previously registered. Electronic watermarking techniques may also be used for copyright protection purposes. Further, the content server 10 may be a server which provides centralized control of copyrights through content ID issuance and management services proposed by the CONTENT ID Forum (cIDf), whose website is found at <http://www.cidf.org>.

While the above-described first embodiment creates sample pictures by degrading image quality, the copyright holders' benefit would be protected without making degradation in several cases. More specifically, when a series of pictures are sold as a single package, a few pictures extracted from the package would be publicized as samples. In this case, customers are charged only when they try to download other pictures. Another similar example is video data. In this case, a still picture extracted from an appropriate video scene will serve as a sample picture. Customers are charged when they try to download other part of the video.

### Sample Picture Delivery Task

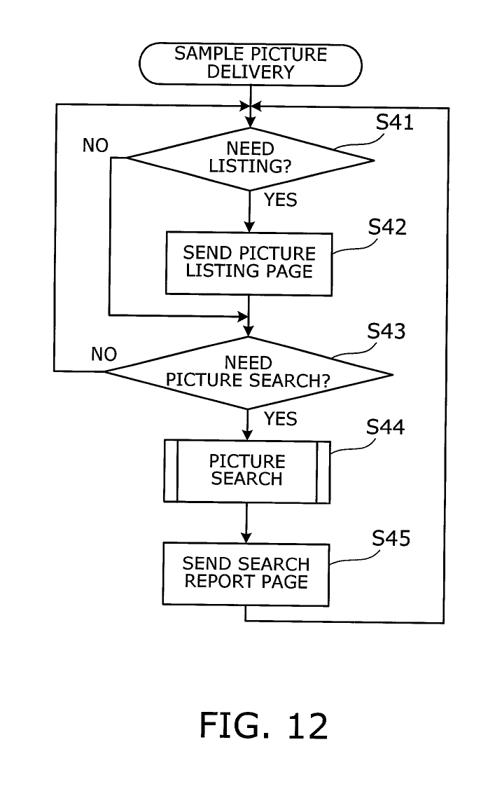

Referring next to the flowchart of FIG. 12, the sample picture delivery task will now be described below. This task is accomplished by executing the following steps:

(S41) The sample picture delivery unit 131 determines whether any terminal station is requesting a picture listing page. If there is such a listing page request, the process advances to step S42. If not, the process skips to step S43.

(S42) The sample picture delivery unit 131 creates a picture listing page containing a list of available sample pictures for delivery to the requesting terminal station.

(S43) The sample picture delivery unit 131 determines whether the terminal station is requesting a picture search. If there is such a request, the sample picture delivery unit 131 passes specified search conditions to the picture searching processor 132, and then advances the process to step S44. If there is no such request, the process returns to step S41.

(S44) The picture searching processor 132 executes a picture search. Details will be provided in a later subsection.

(S45) The sample picture delivery unit 131 receives the search result from the picture searching processor 132. This permits the sample picture delivery unit 131 to compile and send a search report page to the requesting terminal station.

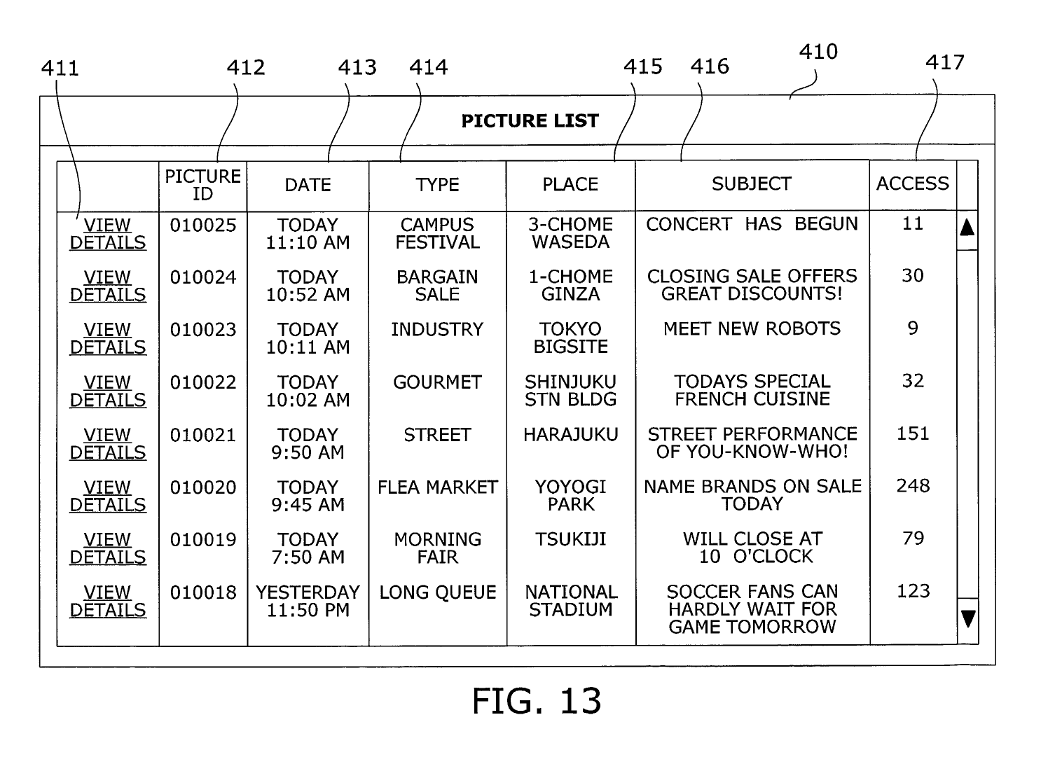

FIG. 13 shows an example of the picture listing page produced in step S42. This picture listing page 410 summarizes the properties of pictures in table form. For each picture entry of the sample picture database 114, it provides the following data fields: a link field 411, a picture ID field 412, a date field 413, a picture type field 414, a place field 415, a subject field 416 and an access counter field 417.

The link field 411 contains a hyperlink that points at a relevant sample picture. This hyperlink reads as follows: “View Details.” A mouse click on the hyperlink 411 will take the user to a sample picture page. The picture ID field 412 shows the picture ID of that sample picture. The date field 413 indicates when the picture was taken. The picture type field 414 shows the category of the picture, which has been defined by the registrant (i.e., registered reporter). The place field 415 contains the name of a place where the picture was taken. The subject field 416 shows the title of the picture, which was given by the reporter at the time of registration. The access counter field 417 indicates how many times the sample picture has been accessed via the hyperlink.

The picture listing page 410 shown in FIG. 13 is only an example, and the items and their arrangement may be modified in various ways. For instance, the hyperlink text in the link field 411 may be replaced with a thumbnail version of pictures, which are produced by shrinking and/or degrading the image of original pictures or sample pictures. As another possible modification, the picture listing page 410 may have some additional columns for supplemental information, such as the sales performance (i.e., the number of downloads) and each reporter's track record (i.e., total sales of his/her pictures).

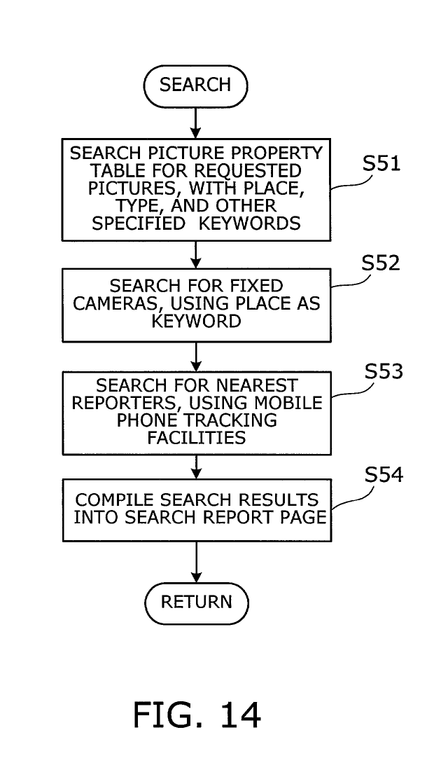

Referring next to the flowchart of FIG. 14, the picture searching routine will be described below. When this routine is called at step S44 of FIG. 12, the content server 10 executes the following steps:

(S51) The picture searching processor 132 searches the picture property table 112, using given search keywords, such as place and picture type, which have been received from the sample picture delivery unit 131.

(S52) The picture searching processor 132 first consults the fixed camera database 113 to find appropriate cameras located in the place specified as a search keyword. This is possible because the fixed camera database 113 stores information about fixed cameras, including their locations.

(S53) The picture searching processor 132 then asks the request routing unit 125 to find an appropriate reporter who is relevant to the place that is specified as a search keyword. Then the request routing unit 125 interacts with the mobile phone tracking facilities in the mobile base station 30, in an attempt to find some registered reporters whose current locations are close to the specified place. If appropriate reporters are found, the request routing unit 125 sends their user IDs back to the picture searching processor 132. Here, the mobile network system notifies the content server 10 of the location of a reporter at a coarse resolution or a fine resolution. In the former case, the reporter location is approximated to the location of a mobile base station that is nearest to the reporter. In the latter case, the intensity of a radio signal is measured at different places, so that the reporter location will be identified more precisely.

(S54) The picture searching processor 132 creates a search report page by compiling the search results obtained in steps S52 and S53. The control is then returned to the calling process, thus making the sample picture delivery task resume from step S45 of FIG. 12.

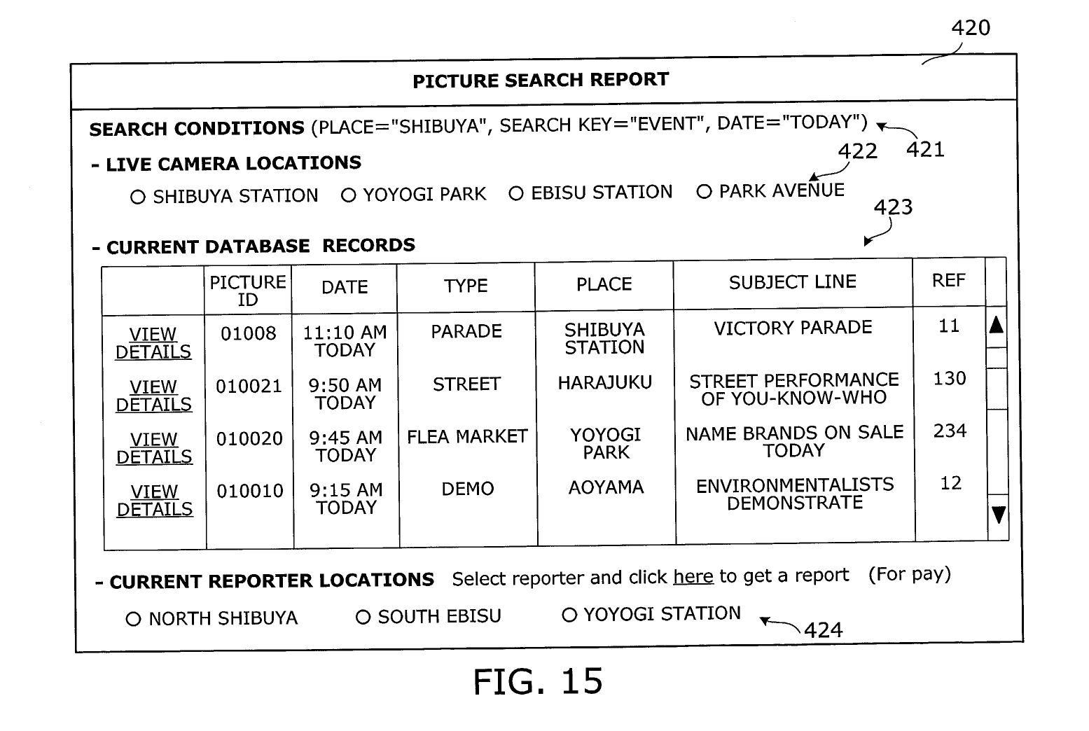

The search report page produced in this way is transmitted to the requesting user's terminal station for display on its monitor screen. FIG. 15 shows an example of this search report page. The illustrated search report page 420 has the following parts: a search condition field 421, a fixed camera listing field 422, a registered picture listing field 423, and a reporter listing field 424.

The user-specified search conditions are displayed in the search condition display field 421. The present example of FIG. 15 shows that the user has specified the following three conditions: (a) Place=“Shibuya,” (b) Search Key=“Event,” and (c) Date=“Today,” where the second condition (b) is used to qualify the database records in terms of whether their picture description field contains the keyword “Event” or not.

The fixed camera listing field 422 shows a list of fixed camera locations suitable for the specified place. In the present example of FIG. 15, the list contains the following camera locations: Shibuya Station, Yoyogi Park, Ebisu Station, and Park Avenue.

The registered picture listing field 423 selectively shows such picture entries that satisfy the specified search conditions among those registered in the content server 10. Those entries are formulated in a table having the same items as those of the picture listing page 410 explained in FIG. 13. The left-most column provides hyperlinks “View Details” to allow the user to jump to another page to see the details of a particular picture.

The reporter listing field 424 shows a list of reporter locations that are close to the specified place. In the present example, three reporter locations are listed: North Shibuya, South Ebisu, and Yoyogi Station.

The above-described picture search functions are employed in the first embodiment to help the users to find desired pictures by specifying picture types, place, date, and other keywords. Besides providing the user with existing pictures in a local database, the proposed search mechanism is designed to recommend some reporters who would assist him/her to obtain a desired picture, even in the cases where no match is found in the database.

The picture searching processor 132 creates and uses index files to realize the full text search capabilities for quick retrieval of picture property information. The picture searching processor 132 also has flexibility in handling place field values. As previously described, the place field may contain the location information in standard latitude-altitude form. Or alternatively, it may contain a plurality of keywords such as street addresses and property names. In the case where the place field is defined in the latitude-altitude format, the picture searching processor 132 translates given keywords (e.g., name of station, park, city, and street) into latitude-altitude coordinate values before starting a database search.

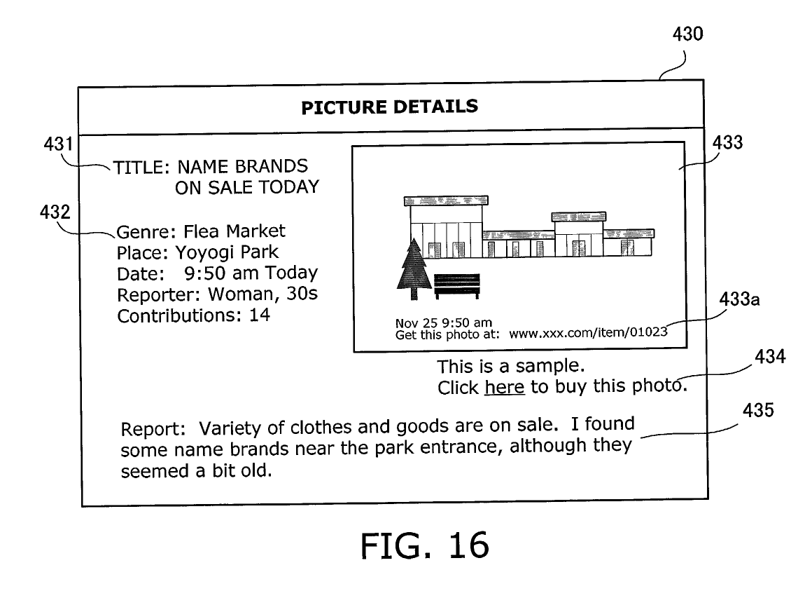

Referring again to FIGS. 13 and 15, the picture listing page 410 and search report page 420 are linked with picture details pages. A click on a hyperlink “View Details” will take the user to another page that is dedicated to the selected picture, so that he/she can check the picture in greater detail. FIG. 16 shows an example of such picture details pages. This picture details page 430 contains the following items: a title field 431, a picture property field 432, a sample picture 433, a hyperlink 434 to a picture shopping page, and a report field 435.

The title field 431 shows the title of the picture, which is “Name Brands on Sale Today” in the present example. The picture property field 432 explains more about the picture, including: picture type, place, date, reporter's profile (i.e., gender and age), and his/her track record (i.e., the number of pictures uploaded). The example page of FIG. 16 shows that the picture of interest falls into the category of “Flea Market” photos and was taken in Yoyogi Park at 9:50 am today by a thirtysomething woman who has contributed fourteen times.

Pasted on the page is a sample picture 433 which was produced by the sample picture generator 122. The sample picture 433 has text information embedded at its bottom portion to indicate the date of capturing, as well as to provide a direct link (URL) 433a to the service provider's website to allow the user to order the picture of interest. The hyperlink 434, when clicked, will take the user to a picture shopping page. In the example of FIG. 16, the underlined word “here” in the message “Click here to buy this photo” works as a link to the corresponding picture shopping page.

The report field 435 shows a reporter's message related to the picture, which is recorded as a picture property. In the example of FIG. 16, this message reads as follows: “Variety of clothes and goods are on sale. I found some name brands near the park entrance, although they seemed a bit old.”

The user clicks the hyperlink 434 on the above-described picture details page to move on to a picture shopping page, where he/she can purchase the non-degraded original photo. The URL 433a embedded in the sample picture 433 serves the same purpose; the user can go to the picture shopping page by selecting the sample picture 433.

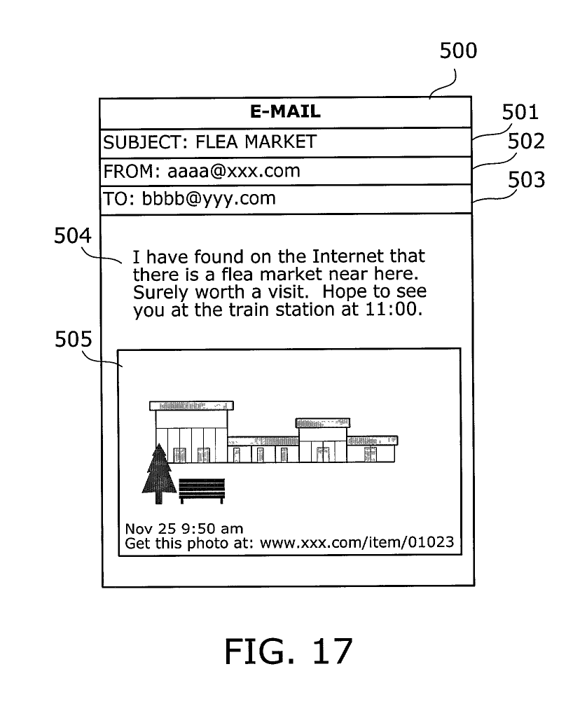

The user is allowed to distribute sample picture data to other users through appropriate communication facilities such as e-mail service. FIG. 17 is a typical screenshot where an e-mail message carrying a sample picture is shown. This e-mail message 500 is composed of the following elements: a subject field 501, a sender field 502, a destination field 503, a text field 504 and an attachment field 505.

The subject field 501 shows the subject of the received e-mail message, which is “Flea Market” in the example of FIG. 17. The sender field 502 and destination field 503 show the source and destination addresses of the e-mail message, respectively. In the example of FIG. 17, the message has been sent from “aaaa@xxx.com” to “bbbb@yyy.com.”

The main text of the e-mail message appears in the text field 504. In the present example, the message reads as follows: “I have found on the Internet that there is a flea market near here. Surely worth a visit. Hope to see you at the train station at 11:00.” If the e-mail message has an attachment (e.g., sample picture), it will appear in the attachment field 505. In the example of FIG. 17, the attachment field 505 contains a copy of the sample picture 433 in the picture details page 430. Alternatively, the sender may include the URL of a sample picture as an e-mail attachment. If this is the case, a click on the URL shown in the attachment field 505 will take the user to a sample picture page.

If such an e-mail message 500 (FIG. 17) is sent to multiple destinations, the sample picture will be exposed to many people's eyes. It has to be noted here that the sample picture has an explicit indication (URL) of how to obtain the original version. This feature enables the e-mail recipients to reach the website for ordering the original picture, simply by entering the URL to their web browser program. Further, the location of a relevant picture shopping page is embedded in a sample picture with the IP3 or similar techniques. With a click on a sample picture, the user can call up a picture shopping page on the content server 10. As seen from the above, the proposed system encourages the users to distribute free sample pictures with embedded ordering information, thus promoting the online sales of picture data.

### Picture Order Processing Task

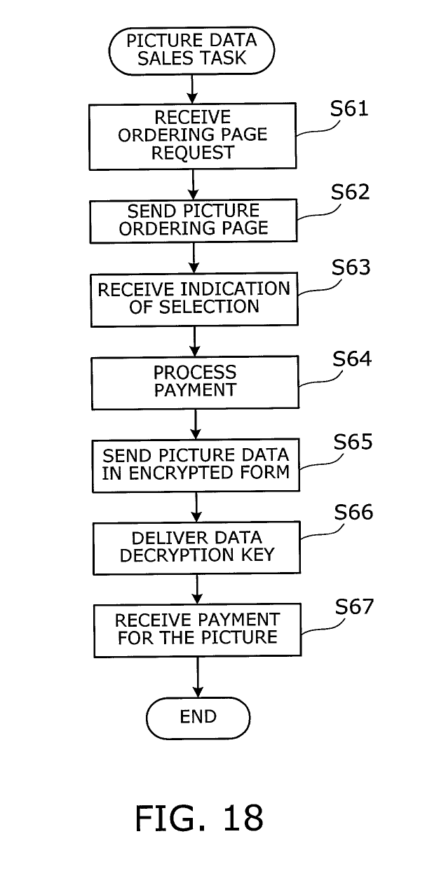

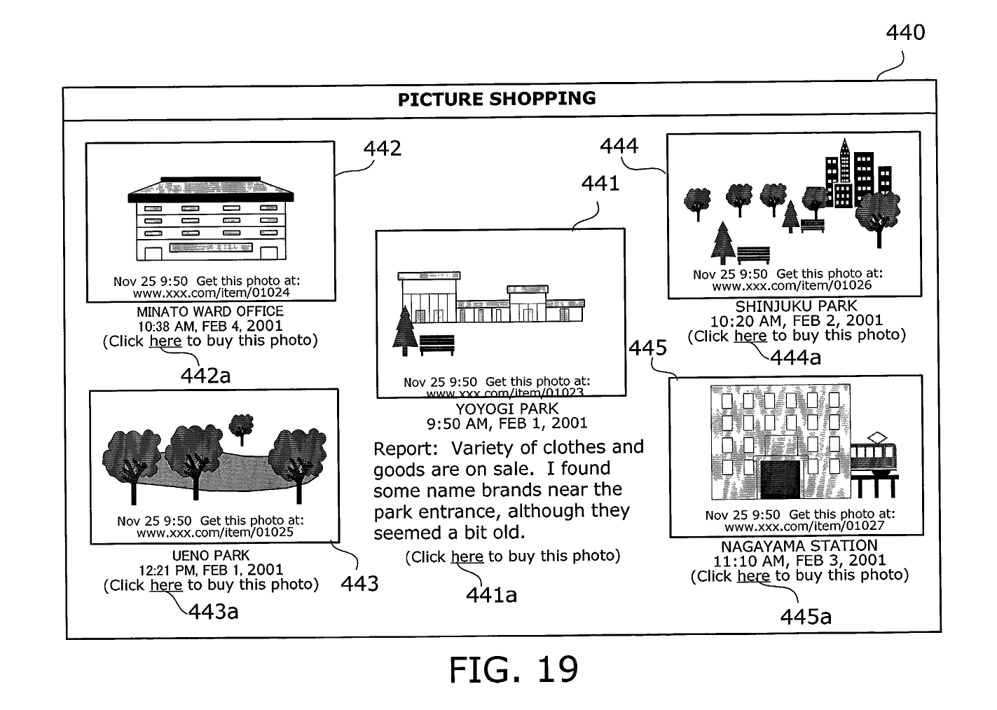

Referring now to FIGS. 18 and 19, this section will describe the picture order processing task. FIG. 18 is a flowchart showing how the proposed content server sells picture data. The content server 10 processes an order for a picture according to the following steps:

(S61) The picture order processor 133 receives an ordering page request from a user's terminal station.

(S62) The picture order processor 133 compiles a picture shopping page containing the sample version of the requested picture and other pictures in the same category. It then sends back the created page to the requesting terminal station.

(S63) A picture selection message from the user arrives at the picture order processor 133.

(S64) The picture order processor 133 interacts with the user to accept his/her payment. One of the popular payment methods is credit card payment. If the user desires this method, the picture order processor 133 first requests him/her to enter his/her credit card information (i.e., credit card holder's name, card number, and expiration date). With this information, the picture order processor 133 sends an inquiry to the credit card company in an attempt to check the credit of the card holder. Another option for the picture order processor 133 is to use a billing service that may be available from a telecommunication carrier or Internet service provider who is operating the content server. It is also possible to accept electronic money payments over the Internet. The user may subscribe to the service on a fixed rate basis or per-usage basis. Thus the picture order processor 133 has to check the user contract and submit a bill for the service accordingly.

(S65) After the payment processing is finished, the picture order processor 133 transmits the original version (i.e., encrypted picture file) of the ordered picture to the user's terminal station.

(S66) According to the encryption/decryption system explained in FIG. 11, the decryption key handler 134 sends a data decryption key to the terminal station. More precisely, this data decryption key is produced within the receiving terminal station, based on the permission data that is supplied from the decryption key handler 134.

(S67) Finally, the picture order processor 133 pays the reporter for the picture that he/she uploaded. More specifically, the content server 10 requests a relevant financial institution to make a bank transfer to the reporter's account, where the service provider deducts a certain amount of commission. Also, the compensation may be paid in the form of electronic money or electronic discount coupons.

FIG. 19 shows an example of the picture shopping page. This picture shopping page 440 contains several sample pictures in the same category. Placed in the center of the page is the sample version of the requested picture 441, being surrounded by other sample pictures 442 to 445. Each sample picture 441 to 445 has a caption “Click here to buy this photo,” where the underlined word “here” is tagged as a link 441a to 445a. A mouse click on the link 441a to 445a will take the user to a payment page which is prepared for the aforementioned task of step S64.

While the same type of sample pictures are collected in the example of FIG. 19, the present invention should not be limited to this arrangement. It is also possible to select pictures on another criterion, such as their “Place” property. If the picture shopping page was not large enough to accommodate all the selected sample pictures, the content server 10 would narrow down the candidates by sorting them in descending order of access count (which implies their popularity). Even in this case, the remaining sample pictures could be included in the picture shopping page in the form of links to their images.

Besides showing the requested picture, the picture shopping page presents other photographs of the same kind to the viewer, thereby stimulating his/her interest, and encouraging purchase of additional works. This feature of the present invention contributes to increased sales of picture data.

### Benefits of the First Embodiment

According to the first embodiment of the present invention, the users of terminals (e.g., mobile phones) are invited to contribute photos through on-line uploading to a content server. The content server distributes a sample version of collected pictures, each carrying embedded ordering information, so that the recipients will be led to a picture shopping page directly and correctly if they wish to buy one. In this way, the proposed system promotes the sales of original version.

Sample pictures are created and distributed for marketing purposes. Since their quality is intentionally degraded, distribution of such sample pictures causes no damage on the copyright holders.

When an order for a picture is received, the content server delivers the original picture in encrypted form, using a security protection mechanism that permits solely the purchaser's terminal station to decode the received data.

The content server provides a series of pages in the course of order processing. The very first page in the series, called the “picture shopping page,” is designed to provide not only the information about the requested picture, but also other sample pictures. This feature stimulates the user's interest, thus promoting the sales of two or more pictures at a time.

### Second Embodiment of the Invention

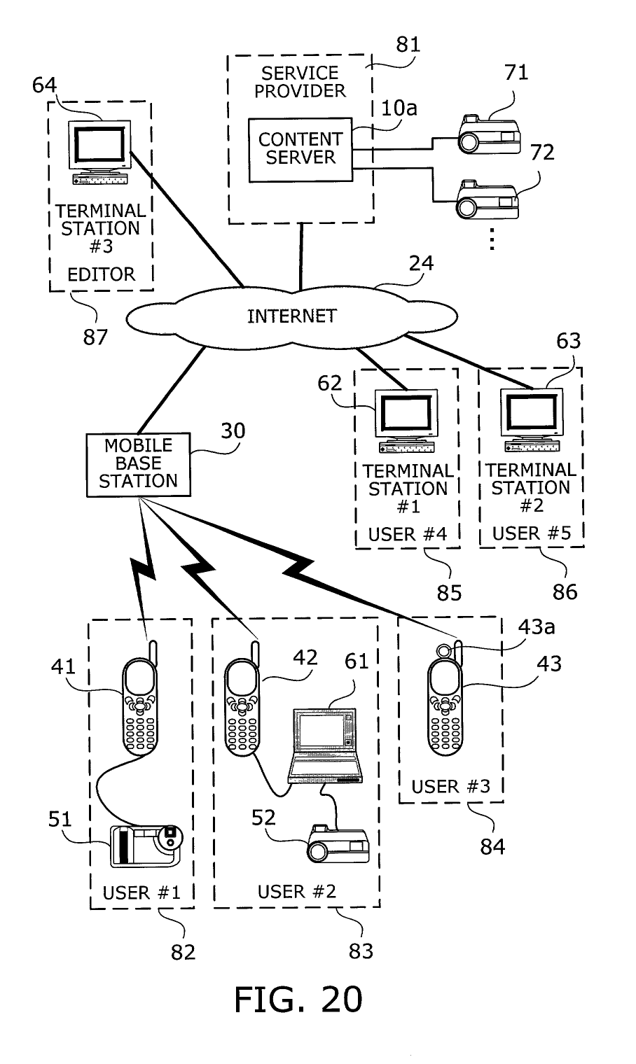

Referring to FIGS. 20 to 24, this section describes a second embodiment of the present invention. In short, the second embodiment covers the functions of the first embodiment, and in addition to that, it allows involvement of an editor who creates pages for the purpose of sales promotion to the third parties, compiling picture data from many contributors. This role of the editor can be assigned to an independent contractor or an employee of the service provider that operates the content server. The following description of the second embodiment assumes an editor of the former type, meaning that the editor receives compensation according to the usage of the pages he/she created. According to one model, the service provider would pay him/her a part of the sales commissions that they earn from the picture shopping page service. Another model is such that the editor includes advertisements in his/her pages, so that he/she can collect fees from the sponsors.

This section describes the second embodiment outlined above, highlighting its differences from the first embodiment. The second embodiment employs many functions common to the second embodiment, which include: displaying picture detail pages, processing picture orders, and encrypting and decrypting picture data files. This section does not provide explanation for those features because they are found in earlier sections.

FIG. 20 is a system configuration according to the second embodiment. The illustrated system differs from the first embodiment in the following two points: (a) the content server 10a has a different internal structure; and (b) another terminal station 64 is involved in the operation. Other entities and configuration are common to the first embodiment, i.e., the system of shown in FIG. 2. Accordingly, the following description of the second embodiment will focus on its distinctive points, while affixing like reference numerals to like elements.

An editor 87 connects himself/herself to the Internet 24 through his/her personal computer, or the third terminal station 64. The terminal station 64 is coupled to the content server 10a through the Internet 24. The hardware configuration explained in FIG. 3 applies also to those terminal station 64 and content server 10a.

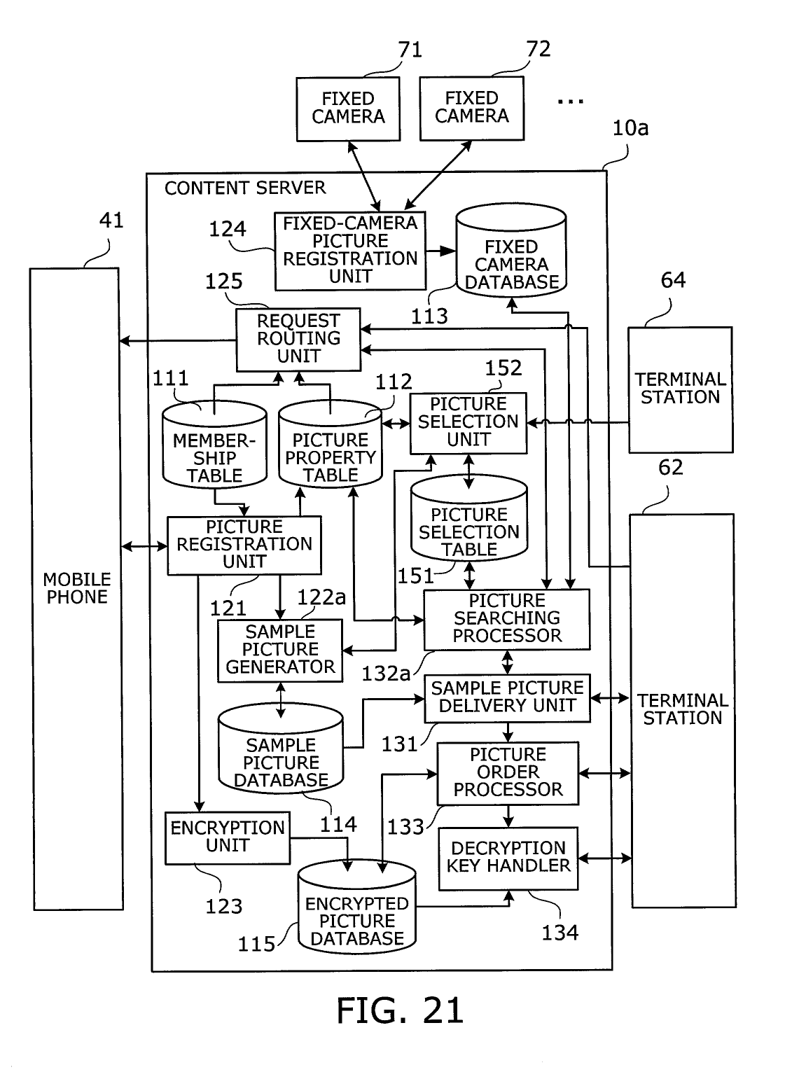

FIG. 21 is a block diagram of the content server 10a according to the second embodiment. While it looks similar to the first embodiment shown in FIG. 5 (and like elements have like reference numerals), the content server 10a of FIG. 21 is distinguishable from the first embodiment in the following points: (a) a picture selection table 151 and a picture selection unit 152 are added; and (b) the functions of the sample picture generator 122 and picture searching processor 132 are modified, and accordingly, modified reference numerals “122a” and “132a” are assigned to the modified version.

The picture selection table 151 is a table containing a particular group of pictures that the editor 87 has extracted from among those listed in the picture property table 112. The picture selection unit 152 provides the editor's terminal station 64 with the information stored in the picture property table 112. Another function of the picture selection unit 152 is to update the picture selection table 151 as requested by the terminal station 64.

Basically, the sample picture generator 122a functions in the same way as its counterpart in the first embodiment (i.e., sample picture generator 122 shown in FIG. 5). According to the second embodiment, however, the sample picture generator 122a generates a sample picture containing information about the editor 87 when requested by the picture selection unit 152. The picture searching processor 132a is also similar to its counterpart in the first embodiment (i.e., picture searching processor 132 shown in FIG. 5). The picture searching processor 132a, however, is designed to search the picture selection table 151, in addition to the picture property table 112.

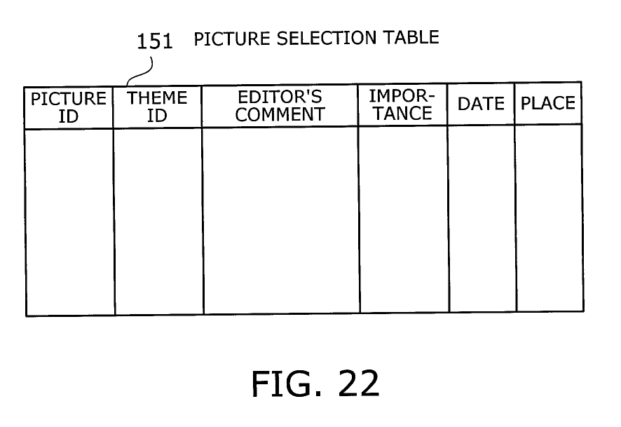

FIG. 22 shows an example of the picture selection table 151. This table 151 has the following data fields for each table entry: “Picture ID,” “Theme ID,” “Editor's Comment,” “Importance,” “Date,” and “Place.” The “Picture ID” field contains the identifier (picture ID) of a picture selected by the editor. The “Theme ID” field stores the theme of the selected picture which is define by the editor. The “Editor's Comment” field is filled out with a comment about the selected picture. The “Importance” field is used to give an importance level of the selected picture; the editor evaluates each selected picture and determines its importance, or recommendation grade. The “Date” and “Place” fields show where and when the selected picture was taken.

The above explanation has assumed a single editor. When there are two or more editors, the picture selection table 151 is created for each individual editor. The editors use the above system to choose a particular set of pictures on the basis of various criteria. More specifically, the editors' roles are:

to evaluate incoming pictures on the fly and grade them in terms of importance or recommendation levels

to select incoming pictures according to a given theme, give a comment to the collected pictures as the whole, and offer a value-added picture set

to watch the access count of each picture in the picture property table 112, analyze the interest and preference of general users, and promote their preferable pictures

to request the registered reporters to collect pictures related to hot topics, and recommend them to other users

The picture selection unit 152 requests the sample picture generator 122a to create a sample picture, each time the editor saves a selected picture into the picture selection table 151. In response to the request, the sample picture generator 122a generates a sample picture containing a piece of information to identify the editor. As a result, each sample picture will gain an editor ID associated with its picture ID. This feature of embedded editor ID makes it possible to sell the original version of a picture through the channel of the editor, even if its sample picture data is copied or mailed.

Besides selecting pictures and commenting on pictures, the editor is allowed to include advertisements in his/her pages, regardless the theme. The service provider prepares advertisement banner images to help the editor choose a desired banner(s). Another banner selection method is such that each sponsor defines a set of keywords in association with their advertisement banner, and a picture collection page created under a specific theme is combined with some banners whose keywords match with the theme of that page. When a created picture collection page has such banners, the editor is entitled to receive compensation in accordance with the number of banner clicks or the “reach” of the advertisements. Here, the term “reach” refers to the number of audiences who saw an advertisement, as opposed to the number of accesses. In measuring the reach, multiple banner clicks by a single person will never contribute to the count.

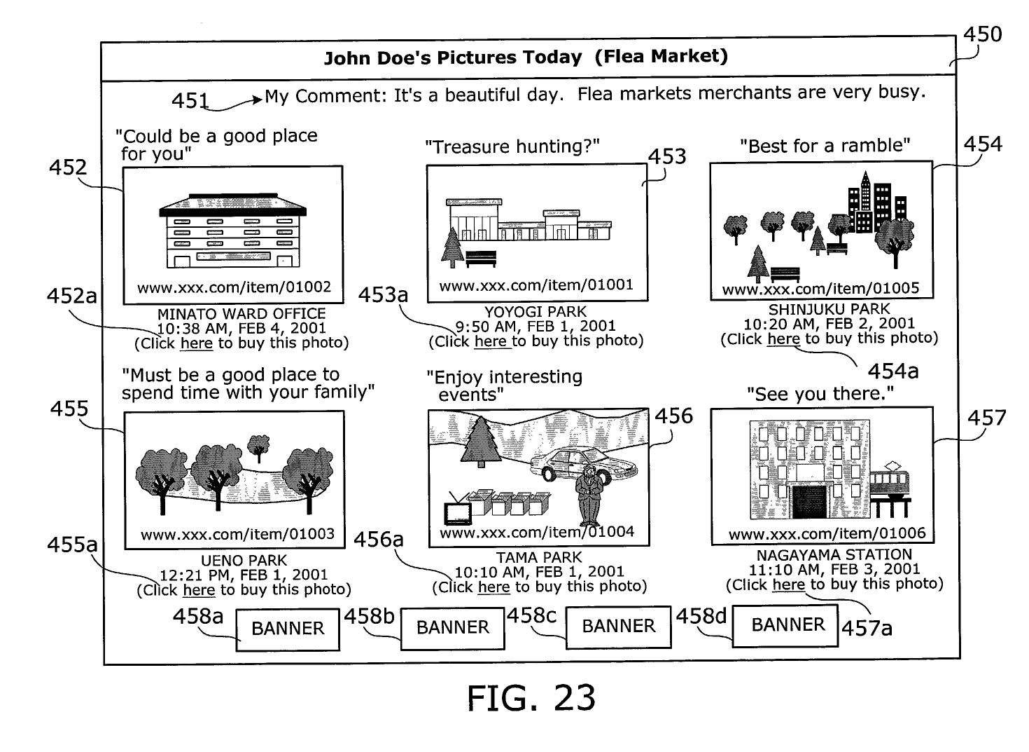

FIG. 23 shows an example of a picture collection page which presents pictures gathered by an editor. This picture collection page 450, compiled by Mr. John Doe under the theme of “Flea Market,” displays a general comment 451 from the editor. In the example of FIG. 23, his comment reads as follows: “It's a beautiful day. Flea markets merchants are very busy.”

The page 450 presents sample pictures 452 to 457 related to flea markets. These sample pictures 452 to 457 contains a URL to an editor-specific picture shopping page. Each sample picture has a caption “Click here to buy this photo,” where the word “here” is tagged as a link 452a to 455a. A mouse click on the link 452a to 455a will lead the user to a payment page which is associated with the editor.

The picture collection page 450 also shows advertisement banners 458a to 458d, which are linked to their respective sponsors' websites. When the user clicks on one of those banners 458a to 458d, he/she will be taken to a corresponding web page. In this way, the system of the second embodiment enables theme-driven picture searching. It is also possible for the user to specify other keywords (e.g., place and picture type) in addition to the theme.

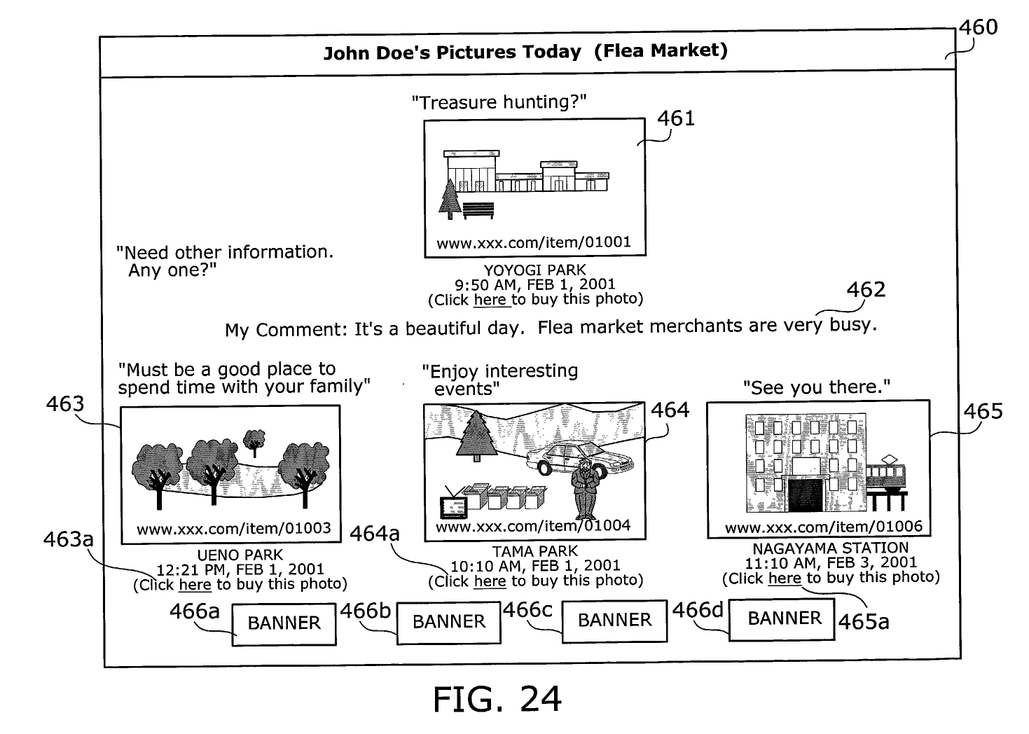

If the user selects one of the sample pictures in the picture collection page of FIG. 23, a picture shopping page will appear on his/her terminal station. FIG. 24 shows an example of such a picture shopping page in the second embodiment. The sample version of the selected picture is located now in the upper half of the illustrated picture shopping page 460. Shown in the lower half is a general comment 462 of the editor John Doe concerning the pictures collected under the theme of “flea market.” The general comment 462 is followed by other sample pictures 463 to 465, and the bottom of the page 460 is allocated to advertisement banners 466a to 466d.

As described above, each sample picture on the picture collection page created by the editor, John Doe, contains information about his/her own picture shopping page 460, thus allowing the user to visit there by simply selecting that sample picture. The picture shopping page is designed to promote more pictures by showing other pictures in the editor's collection as well. While the example of FIG. 24 includes sample pictures in the page, it is also possible to configure the page to show only the links for some of those samples, instead of their images.

### Benefits of the Second Embodiment

The second embodiment of the present invention brings the following benefits in addition to those in the first embodiment. First, the system of the second embodiment is flexible enough to keep track with ever-changing needs of users because of its capability of screening registered pictures. The proposed system can provide users with their desired pictures, eliminating the need for searching the picture database which tends to contain both valuable ones and worthless ones. This feature of the second embodiment makes the system more user-friendly. It also works effectively in inviting customers to editors' web pages, as well as promoting picture sales through their channels. Such positive effects on business (e.g., increased earnings of commissions and advertisement fees) will make their life easier.

### Applications of the Present Invention

The present invention can be applied to various facilities and services, including:

(1) Scoop Information Outsourcing

Photographs used in newspapers and other publications must be true and fair. This ethical requirement is considered to be so important that the mass media companies such as newspaper publishers are reluctant to purchase pictures from other sources. Contributions from amateur photographers are rarely accepted. Basically, they rely on their own sources, employing in-house reporters and cameramen. News agencies with established reliability are another important photo source for them. Because of this limited acceptance of information sources, the mass media coverage tends to be directed to nationwide topics, failing to pick up local events.

The present invention encourages ordinary people to contribute their digital photos to mass media. Even a local event or accident can be reported by a person who happened to be in that location. This feature of the present invention expands the media coverage to serve individual needs for latest visual information on a particular event. Picture data is uploaded from a mobile handset, and the server immediately processes it, so that the pictures will be browsed in a realtime manner.

(2) Travel Information Service

Suppose that a person is planning a trip to a certain region in the country. The system of the present invention helps him/her receive visual information from reporters in the remote location that he/she is going to visit. More specifically, he/she can check the weather and other conditions (e.g., the progress of autumn leaves) beforehand. It is also possible to see whether the planned destination is crowded, without actually visiting there. Depending on such advance information, he/she may want to change the route or destinations. Since most likely information sources in this case are travelers, their visual reports are considered to be more realistic than those found in a travel agency's brochures.

(3) Event Information Service

The proposed system informs many people of what events are happening in a city. Such topics may relate to: business events (e.g., bargain sales, exhibitions, expositions, campaigns), activities in a local community (e.g., flea markets), street performances, shoppers lining up for particular goods, movies, campus festivals, and restaurants (e.g., today's recommendation). People can exchange information about such events, including images in a message to their friends. That is, the present invention provides an effective way of communication.

### Computer Programs Implementing the Invention

The above-described processing functions of the present invention are realized on a client and server environment. More specifically, the functions of the content server (or picture data delivery system) are implemented as server programs, while those of the terminal stations (or picture data purchasing system) are provided as client programs. Various services of the proposed content server are realized by executing the server programs on an appropriate server computer. Likewise, the functions of the proposed terminal station are realized by executing the client programs on an appropriate client computer.

The above server and client programs are stored in a computer-readable medium for the purpose of storage and distribution. Suitable computer-readable storage media include magnetic storage media, optical discs, magneto-optical storage media, and solid state memory devices. Magnetic storage media include hard disk drives (HDD), floppy disks (FD), and magnetic tapes. Optical discs include digital versatile discs (DVD), DVD-RAM, compact disc read-only memory (CD-ROM), CD-Recordable (CD-R), and CD-Rewritable (CD-RW). Magneto-optical storage media include magneto-optical discs (MO).

Portable storage media, such as DVD and CD-ROM, are suitable for the circulation of the server and client programs. Network-based distribution of software programs is also possible, in which case the client program files stored in a server computer are downloaded to client computers via the network.

The server computer has server programs in its local storage unit, which have been previously installed from a portable storage media. The server computer executes the server programs read out of the local storage unit, thereby providing its intended functions. Alternatively, the server computer may execute those programs directly from the portable storage media.

The client computer, on the other hand, stores client programs in its local storage unit, which have been previously installed from a portable storage media or downloaded from the server computer. The client computer provides its intended functions by executing the client programs read out of the local storage unit. As an alternative way of program execution, the client computer may execute the client programs directly from the portable storage media. Another alternative method is that the server computer supplies the client computer with client programs dynamically, allowing the client computer to execute them upon delivery.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A method of distributing picture data over a network of computers, comprising the steps of:
(a) storing picture data received from a mobile station over the network, wherein the stored picture data contains the original version of a picture;
(b) creating a sample picture from the stored picture data, wherein the sample picture contains ordering information that describes where to purchase the original version of the picture; and
(c) transmitting the sample picture to a terminal station on the network, in response to a request from the terminal station.

2. The method according to claim 1, wherein the ordering information given in said creating step (b) includes a location and a file name of a picture ordering page that has to be used to apply for a purchase of the original version of the picture.

3. The method according to claim 2, further comprising the steps of:
(d) when a request for the picture ordering page is received from the terminal station or another terminal station on the network, sending the picture ordering page to said requesting terminal station; and
(e) transmitting the original version of the picture to the requesting terminal station, upon receipt of the application for the purchase.

4. The method according to claim 3, wherein:
said storing step (a) comprises the substep of encrypting the picture data so as to create an encrypted picture file; and
said transmitting step (c) transmits the encrypted picture file to the requesting terminal station, together with permission data necessary for extracting the picture data from the encrypted picture file.

5. The method according to claim 2, wherein:
said storing step (a) comprises the substep of classifying the received picture data into groups; and
the picture ordering page presents information about at least two pictures in the same group, including the picture stored at said storing step (a).

6. The method according to claim 5, wherein the picture ordering page contains sample pictures created from said at least two pictures.

7. The method according to claim 1, wherein said creating step (b) creates the sample picture by degrading image quality of the picture data.

8. The method according to claim 1, further comprising the step (f) of receiving a shooting condition record from the mobile station, and storing the received shooting condition record in association with the received picture data.

9. The method according to claim 8, further comprising the step (g) of searching the shooting condition record in response to a search request from another terminal station on the network, so as to create a list of pictures that meet the search request.

10. The method according to claim 1, wherein further comprising the steps of:
(h) in response to instructions from an editor, selecting at least one picture out of the stored picture data;
(i) creating a picture promotion page containing information about the selected picture; and
(j) paying compensation to the editor, depending on sales performance of the picture shown in the picture promotion page.

11. A method, for use with a terminal station on a network, to purchase picture data from a computer storing pictures, the method comprising the steps of:
(a) receiving a sample picture from the computer, wherein the sample picture contains ordering information that describes where to purchase an original version of a particular picture; and
(b) in response to an instruction from a user of the terminal station, placing an order for the picture data according to the ordering information contained in the sample picture.

12. A program product, for use with a computer, for distributing picture data over a network, the program product causing the computer to perform the steps of:
storing picture data received from a mobile station over the network, wherein the stored picture data contains the original version of a picture;
creating a sample picture from the stored picture data, wherein the sample picture contains ordering information that describes where to purchase the original version of the picture; and
delivering the sample picture to a terminal station on the network, in response to a request from the terminal station.

13. A program product, for use with a computer system on a network, for purchasing picture data from a server computer storing pictures, the program product causing the computer system to perform the steps of:
receiving a sample picture from the server computer, wherein the sample picture contains ordering information that describes where to purchase the picture data; and
in response to an instruction from a user of the computer system, placing an order for the picture data according to the ordering information contained in the sample picture.

14. An apparatus for distributing picture data over a network, comprising:
storage means for storing picture data received from a mobile station over the network, the stored picture data containing the original version of a picture;
creating means for creating a sample picture from the stored picture data, the sample picture containing ordering information that describes where to purchase the original version of the picture; and
transmission means for transmitting the sample picture to a terminal station on the network, in response to a request from the terminal station.

15. A computer-readable medium which stores a program for distributing picture data over a network, the program causing a computer to perform the steps of:
storing picture data received from a mobile station over the network, the stored picture data containing the original version of a picture;
creating a sample picture from the stored picture data, wherein the sample picture contains ordering information that describes where to purchase the original version of the picture; and
transmitting the sample picture to a terminal station on the network, in response to a request from the terminal station.
